(19) United States
(12) Patent Application Publication
(10) Pub. No.: US 2007/0016614 A1
(43) Pub. Date: Jan. 18, 2007

(54) METHOD AND APPARATUS FOR PROVIDING STRUCTURED DATA FOR FREE TEXT MESSAGES

(76) Inventor: Alon R. J. Novy, Maroubra (AU)

Correspondence Address: DOV ROSENFELD, 5507 COLLEGE AVE, SUITE 2, OAKLAND, CA, 94618, US

(21) Appl. No.: 11/457,873

(22) Filed: Jul. 17, 2006

Related U.S. Application Data
(60) Provisional application No. 60/700,041, filed on Jul. 15, 2005.

(51) Int. Cl. G06F 17/00

(52) U.S. Cl. 707/104.1

(57) ABSTRACT

Presented herein are methods for providing structured data from authored messages. Also presented herein are software products, e.g., in the form of carrier media each carrying computer readable instructions that when executed by a processor of a processing system, carry out methods for authoring messages, and systems making use of such methods and software products. The methods are particularly applicable messages authored in relation to the planning, executing, controlling, evaluating and reporting of human collaborative undertakings, such that authoring is performable by a user in a fashion familiar from prior art methods, including word processing, email, and other free-text authoring software systems. Structured data is provided from the authoring process, and this data is, in some implementations, provided to an activity management system for the purpose of updating records maintained by that system.

### RELATED PATENT APPLICATIONS

The present invention claims priority of and is a conversion of U.S. Provisional Patent Application No. 60/700,041 to inventor Novy, filed 15 Jul. 2005, titled METHOD AND APPARATUS FOR AUTHORING DOCUMENTS, and having Agent/Attorney Ref. No. THINK102P. The contents of U.S. Provisional Patent Application No. 60/700,041 are incorporated herein by reference.

### BACKGROUND

This invention relates to electronic message creation methods, and more particularly to a computer-implemented method for providing structured data from electronic free-text messages during the creation of the message, this structured data representing the intended meaning(s)—the “semantic content”—of the message, the structured data represented in a data structure, e.g., a database.

Various forms of activity management systems are known. By an activity management system is meant a computer-based system for managing activities, risks, and/or issues by providing information that relates to these activities, risks, and/or issues, and for processing this information. Examples of such computer-based activity management systems include computer-based project management systems, operational risks and issues management systems, bug/defect tracking systems, resource scheduling systems, management dashboards that provide summaries and overviews of current activities, management and executive reporting systems, activity/risk/issue/change request management systems, compliance systems such as standards and regulatory compliance systems, and knowledge management systems.

Activity management systems typically provide an electronic infrastructure for assisting in the activities and processes involved in the planning, executing, controlling, evaluating and reporting of human collaborative undertakings. These include non-repeating undertakings—such as individual projects—as well as repeating and/or on-going undertakings—such as usual business activities.

Generally speaking, activity management systems are provided with data, e.g., in the case of project management and the like, such data indicative of project factors such as deadlines, timeframes, tasks and task allocations, resources and resource allocations, risks, workflows, and so on. The general term for such factors when applied to activity management systems is “activity factors.” Continuing with the project management example, the project management system in turn provides an interface through which persons are able to view and assess aspects of the entity or project or activity as matters progress. In one project management example a project manager uses a project management system to track the progress of a particular project, including performing an assessment of tasks that are outstanding, the persons responsible for those tasks, and the implications of task completion times on the project as a whole.

The practical effectiveness of an activity management system is often highly dependent on the degree to which persons involved with a given managed activity provide the system with relevant data indicative of managed factors. Such relevant data accumulates rapidly as a result of human interactions by way of meetings, phone conversations and email.

A great deal of time and effort is required on the part of activity management system users to ensure that data stemming from human interactions is provided to the activity management system. This time and effort is often spent retrospectively—data stemming from a particular human interaction (or other managed activity) is provided to the system after (and in some cases long after) the occurrence of that interaction. This affects the reliability of the system at a given point in time, and is resource intensive. These factors are often seen as a deterrent to the use of activity management systems.

Activity management systems typically store data using structured data methods wherein the information captured is organized into discrete structured data objects of known type, with each structured data object typically including at least one data field of known type and value. A collection of structured data object type definitions is commonly referred to as a “schema.” Typically, the structured data objects are stored in at least one data repository, e.g., a database, and the contents of each repository are made available to the various participants according to their respective security clearances.

In the case of emails, it is known in some instances for managers that use an activity management system to periodically—for example at the end of each day or week—review emails received and sent to assess data that should be provided to the activity management system.

There is a need in the art for methods, systems and apparatuses that streamline the processes involved in providing data indicative of managed factors to activity management systems such that this data is reliably provided to the system in a timely and resource conservative manner. There further is a need in the art for converting data provided using text messaging into a structured format for a system such as an activity management system.

There are some known techniques for directly providing structured data. In one example, a user authors information by means of a purpose-designed electronic form. The form includes fields relating to particular structured data types, and by completing these fields and submitting the form, a user provides structured data to update records in a database. For example, a “task form” allows a project manager to allocate a task to an employee by entering into predefined fields data indicative of the task, priority, allocated employee, deadlines, and so on. Examples of software products that can be used for authoring structured data as such for use specifically in project management systems include the Primavera (™) and Niku (™) products.

The approach of using forms to provide structured data often results in similar failings to those discussed above. For example, the effectiveness is reliant on the appropriate and consistent use of forms. Additionally, filling out forms is time consuming—particularly in situations where the data stems from a past human interaction.

A similar approach to the use of forms involves the selecting of templates by a user. In such an approach, a user selects a type of message—for example a message for allocating a task. For a given type of message, there is a template that sets out what information is required to be authored, and what information is optionally authored. The data is entered, e.g., via a form or some other manner that requires the user to input the information required to be authored and that provides for optional entry of information that is optional. The authoring and sending of a message authored by way of such a template results in the providing of structured data. The type of message in some instances further determines the set of message types that are available to the recipient of the first message for responding or carrying out another messaging task in response to the received message. Examples of such structured data methods are described in U.S. Pat. No. 5,208,748 and U.S. Pat. No. 6,708,201. Use of such templates is similar to the use of forms. It is different from how embodiments of the present invention use what are herein called “message templates.”

This approach inherently restricts how persons communicate, and arguably deprives interpersonal messaging of a valuable human element. Further, its effectiveness is reliant on willingness of participants to appropriately use the templates in all cases.

According to yet another type of structured data method, the user operates an editing product to mark portions of an entered document and in doing so identifies the meaning of the marked portions. The markers are typically defined according to a schema, where that schema is either pre-determined or inferred from the use of the markers in the document. One example of such a method that uses a pre-determined schema that is specific to project management is the so-called Project Management Extensible Markup Language (PMXML). For an example, see http://xml.coverpages.org/projectManageSchema.html.

Whilst this approach retains something of the human element in communication, it is somewhat time consuming and not necessarily intuitive to use. A user is given the responsibility of reviewing the meaning of a document, and subsequently reinforcing this meaning by text marking.

Thus there is a need in the art for computer implemented methods that accept text for messaging and that convert the text to structured form for use in a system such as an activity management system. The text and the structure can then be sent as a message to one or more recipients.

### SUMMARY

Described herein is a method for authoring composite data messages and a software product, e.g., in the form of a carrier medium that carries computer-readable instructions that when executed on one or more processors of a processing system, cause the processing system to implement the method. Each composite data message is configured for receiving by at least one recipient for use, for example, in activity management. Such a message includes one or both free-text and, after conversion of the free-text, structured data, wherein the structured data represents the intended meaning(s) of the free-text. According to one embodiment of the present invention, the structured data includes at least one structured data object representing the meaning of one text fragment of the free-text, and none or more relationships, e.g., typed references, between such structured data objects, each relationship representing a corresponding relationship between the corresponding text fragments. As is common in the art, the term “none or more” for a quantity of elements is used herein to mean no elements, or if there is at least one element, the one or more elements. That is, “none or more relationships” means optionally at least one relationship.

According to one embodiment, the method further includes providing for the automated conversion of free-text to structured data, wherein the conversion is performed iteratively and incrementally during the authoring and results in a provisional data state for at least one part of the structured data, e.g. a structured data object or data field. Additionally, the method provides for incremental user approval and correction of such provisional data states. Once approved, the data state of the approved structured data part is considered correct, and is no longer subject to automated changes. According to one embodiment, further manual changes to previously approved constituents of the structured data are still possible. Further according to one embodiment, changes to a text fragment subsequent to the approval of the corresponding structured data revoke the approved status of the corresponding structured data.

According to one embodiment, conversion decisions include using at least one schema, none or more message templates, none or more pre-determined life-cycles associated with a given structured data object type, and none or more pre-determined workflows for messages.

Further, according to one embodiment, the method includes displaying a visual model of the structured data of the message to the user.

One embodiment includes a method for providing structured data from a message for sending to one or more recipients, the method comprising:
(a) accepting input indicative of a text fragment of the message;
(b) analyzing the accepted input to ascertain whether one or more predefined text conditions are met;
(c) in the case it is ascertained that one or more of the predefined conditions are met providing to a user output indicative of proposed structured data corresponding to the accepted input;
(d) accepting from the user additional input indicative of selective modification and/or approval of the proposed structured data; and
(e) repeating steps (a) to (d) until all data indicative of all text fragments included in the message are accepted and analyzed,

such that in the case that all data indicative of all text fragments included in the message are accepted, analyzed, and the structured data thereof modified and approved, one or both of the approved structured data and the message are sendable to one or more recipients.

One embodiment further includes, in the case that all data indicative of all text fragments included in the message are accepted, analyzed, and the structured data thereof modified and approved, sending one or both of the approved structured data and the message to one or more recipients.

In one embodiment, the sending in (f) is in response to an explicit command to send being provided by the user.

In one embodiment, the sending in (f) is in response to an explicit command that all text and structured data is approved.

In one embodiment, the text fragment is provided as free text.

In one embodiment, the message is created by the user. In another embodiment, the message is created by another user different from the user.

In one embodiment, analyzing of (b) includes one or both of analyzing the accepted input corresponding to the text fragment, and analyzing the relationship of the text fragment to one or more previously accepted inputs corresponding to text fragments.

In one embodiment, the analyzing of (b) includes one or both of analyzing the accepted input corresponding to the text fragment, and analyzing the approved structured data corresponding to one or more previously accepted inputs corresponding to text fragments.

In one embodiment, the free text is provided during creating of an electronic message.

In one embodiment, one or more predefined text conditions is associated with one or more structured data types, and the proposed structured data includes one or more of the structured data types associated with the met text conditions.

One embodiment includes the step of providing a framework for the association of text conditions to structured data types.

In one embodiment, the method is implemented in an environment and the association of text conditions to structured data types is environment specific.

One embodiment includes the step of identifying one or more structured data types associated with the met text conditions.

One embodiment includes the step of analyzing the one or more identified structured data types for identifying a preferred selection of structured data types.

In one embodiment, the preferred selection of structured data types includes one or more or all of the identified structured data types.

In one embodiment, analyzing the one or more identified structured data types includes applying a selection protocol that is included in a mapping protocol for mapping between free-text and structured data.

In one embodiment, the mapping protocol includes one or more of the following:
a confidence level assessment;
assessment of previously approved structured data;
analysis of one or more attributes associated with the user;
analysis of one or more attributes associated with one or more of the recipients;
analysis of one or more relationship attributes relating to the user and one or more of the recipients;
analysis of one or more attributes associated with a related message.
analysis one or more attributes associated with one or more data types; and
application of data derived by a learning algorithm.

In one embodiment, each data type is indicative of one or more detail fields.

In one embodiment, the output indicative of proposed structured data provides one or more of the detail fields of which the structured data types included in the proposed structured data are indicative.

In one embodiment, the providing of the additional input indicative of selective modification and/or approval of the proposed structured data includes editing and or approving information in the provided detail fields.

In one embodiment, one or more of the data fields are pre-determined to be a mandatory data field and sending is permitted only in the case that each of the provided mandatory detail fields is populated.

In one embodiment, at least one detail field is associated with one or more pre-determined validity conditions, e.g., the allowable type and allowable maximum length for data for populating the detail field, and sending is permitted only in the case that all applicable validity conditions are met.

In one embodiment, one or more of the provided detail fields are automatically populated based on the analysis of the text.

In one embodiment, for each data type the detail fields relate to aspects of that data type.

In one embodiment, the detail fields include detail fields that relate to any one or more of:
deadlines or other dates;
classifications;
resource allocations;
priority rankings;
responsibility allocations;
task acceptances or rejections.

In one embodiment, either or both of the detail fields and the data type are provided in a graphical user interface as modifiable components.

In one embodiment, the step of providing a signal indicative of proposed structured data is performed upon one or more predetermined conditions being met.

In one embodiment, the one or more predetermined conditions include any one or more of:
a user input;
input indicative of completion of receipt from the user input indicative of text; and
input indicative of completion of receipt from the user input indicative of a discrete fragment of text.

In one embodiment, input indicative of a discrete segment of text includes input indicative of a paragraph of text.

In one embodiment, the text is displayed to the user by way of a graphical user interface in a free-text message field and the signal indicative of proposed structured data is provided in, on and/or adjacent the free-text message field.

In one embodiment, the signal includes a tree diagram indicative of the proposed structured text.

In one embodiment, the tree diagram is provided in a structured text preview field alongside the free-text message field.

In one embodiment, the signal includes one or more modifiable items periodically superimposed on the free-text message field.

In one embodiment, a signal indicative of the approved structured data is provided to an information management system.

In one embodiment, the information management system is an activity management system.

In one embodiment, the information management system is responsive to the signal indicative of the approved structured data for updating one or more records in a database.

In one embodiment, the information management system is responsive to the signal indicative of the approved structured data for providing a signal indicative of a follow-up action.

In one embodiment, the signal indicative of the approved structured data is provided to the information management system in response to one or more predetermined conditions being met.

In one embodiment, the one or more predetermined conditions include a user command to provide an electronic message including the text.

In one embodiment, the one or more predetermined text conditions include any one or more of the following:
the presence of one or more predetermined key words;
the presence of one or more predetermined grammatical structures;
the presence of one or more predetermined text structures;
the presence of one or more predetermined identifiers.

In one embodiment, one or more predetermined text structures include text structured to identify a date or other point in time.

In one embodiment, the one or more predetermined identifiers are indicative of one or more resources, items, projects, persons or locations.

In one embodiment, the message consists of a single text fragment.

In one embodiment, the output provided in (c) includes one or more modifiable components presented in a graphical user interface.

One embodiment includes a computer-readable carrier medium carrying a set of instructions that when executed by one or more processors cause the one or more processors to carry out a method for providing structured data from a message created by a user for sending to one or more recipients, the method comprising:
(a) accepting input indicative of a text fragment created by the user;
(b) analyzing the accepted input to ascertain whether one or more predefined text conditions are met;
(c) in the case it is ascertained that one or more of the predefined conditions are met providing to the user output indicative of proposed structured data corresponding to the accepted input;
(d) accepting from the user additional input indicative of selective modification and/or approval of the proposed structured data;
(e) repeating steps (a) to (d) until all data indicative of all text fragments included in the message are accepted and analyzed;
(f) in the case that all data indicative of all text fragments included in the message are accepted, analyzed, and the structured data thereof modified and approved, sending one or both of the approved structured data and the message to one or more recipients.

In one embodiment, the carrier medium is a medium bearing a propagated signal detectable by at least one processor of the one or more processors and representing the set of instructions.

In one embodiment, the carrier medium is a carrier wave bearing a propagated signal detectable by at least one processor of the one or more processors and representing the set of instructions.

In one embodiment, the carrier medium is a transmission medium in a network bearing a propagated signal detectable by at least one processor of the one or more processors and representing the set of instructions.

One embodiment includes a computer program or computer program product comprising a set of instructions for carrying out a method as recited above.

One embodiment includes a system for providing structured data from a message created by a user for sending to one or more recipients, the system comprising:
(a) a first interface for accepting input indicative of a text fragment created by the user;
(b) a first processor for analyzing the accepted input to ascertain whether one or more predefined text conditions are met;
(c) a second processor for, in the case that it is ascertained that one or more of the predefined conditions are met, providing to the user output indicative of proposed structured data corresponding to the accepted input;
(d) a second interface for accepting from the user additional input indicative of selective modification and/or approval of the proposed structured data;
(e) a third processor for instructing the first interface to receive further input indicative of a text fragment until all data indicative of all text fragments included in the message are accepted and analyzed; and
(f) a fourth processor for, in the case that all data indicative of all text fragments included in the message are accepted, analyzed, and the structured data thereof modified and approved, sending one or both of the approved structured data and the message to one or more recipients.

### BRIEF DESCRIPTION OF THE DRAWINGS

FIG. 1 shows in simplified form an embodiment of a method for providing structured data from a message created by a user for sending to one or more recipients, the method including one or more aspects of the present invention.

FIG. 2A shows an exemplary information system implementing the method embodiment of FIG. 1.

FIG. 2B shows another exemplary information system implementing the method embodiment of FIG. 1.

FIG. 2C shows another exemplary information system implementing the method embodiment of FIG. 1.

FIG. 3 is a simplified representation of an exemplary screenshot produced by a message authoring system such as in FIG. 2A that includes one or more aspects of the present invention.

FIG. 4 is a flowchart showing an embodiment of a method for providing structured data from a message created by a user for sending to one or more recipients according to another embodiment of the present invention.

FIG. 5 shows in simplified form a flowchart of one embodiment for authoring composite data messages in accordance with the invention.

FIG. 6 shows in simplified form a flowchart of one embodiment for determining a provisional fragment data class for a new text fragment.

FIG. 7 shows in simplified form a flowchart of one embodiment of an exemplary expected succession plan of fragment data classes in a composite data message template for email.

FIG. 8 shows in simplified form a class diagram of an exemplary containment relationship between fragment data classes defining risk, mitigation and residual risk fragment data objects, according to one or more aspects of the invention.

FIG. 9 shows in simplified form a class diagram of an exemplary hierarchy of fragment data classes, such as can be used for composite data messages for use in activity management, according to one or more aspects of the invention.

FIG. 10 shows an exemplary mapping aid that is a lexical relation, relating a keyword or key phrase and a fragment data class, according to one or more aspects of the invention. Also shown is a plurality of instances of this relation.

FIG. 11 shows an exemplary mapping aid that is a grammatical relation, relating grammatical structure and a fragment data class, according to one or more aspects of the invention. Also shown is a plurality of instances of this relation.

FIG. 12 shows an exemplary mapping aid that is a relation, relating a keyword or key phrase, a fragment data class, a data field, and a value assignment. Also shown is a plurality of instances of this relation.

FIG. 13 shows an exemplary mapping aid that is a relation, relating a search pattern, a fragment data class and a data field, according to one or more aspects of the invention. Also shown is a plurality of instances of this relation.

FIG. 14 shows in simplified form a user interface embodiment for authoring structured electronic messages.

FIG. 15 shows pseudo-code that illustrates how, in one embodiment, a mapping decision is made based on evaluating at least one available mapping consideration.

FIG. 16 shows pseudo-code that illustrates one embodiment of a tie-breaker used in one implementation.

FIG. 17 shows pseudo-code that illustrates one method for determining if a containment relationship definition is a relevant mapping consideration in the current mapping operation, in accordance with one embodiment of the invention.

FIG. 18 shows pseudo-code that illustrates one method embodiment for finding a relevant succession plan.

FIG. 19 shows pseudo-code that illustrates one method embodiment for determining if a succession relationship definition is a relevant mapping consideration in the current mapping operation, according to an aspect of the present invention.

FIG. 20 shows pseudo-code that illustrates one embodiment for creating appropriate relationships for a new fragment data object, according to an aspect of the present invention.

FIG. 21 shows pseudo-code for exemplary conditional logic for a mapping aid applied to a fragment data object of class “Mitigation” according to an aspect of the present invention.

Like reference numbers and designations in the various drawings indicate like elements.

### DETAILED DESCRIPTION

Presented herein are methods for authoring composite messages, and in particular, for providing structured data from created free-text messages. Also presented herein are software products, e.g., in the form of carrier media each carrying computer readable instructions that when executed by a processor of a processing system, carry out methods for authoring composite messages, and systems making use of such methods and software products. The methods are particularly applicable to messages authored in relation to the planning, executing, controlling, evaluating and reporting of human collaborative undertakings, such that authoring includes creating messages by a user in a fashion familiar from prior art methods, including word processing, email, and other free-text message creation software systems. Structured data is provided from the authoring process, and this data is, in some embodiments, provided to an activity management system for the purpose of updating records maintained by that system.

As is common in the art, the term “none or more” for a quantity of elements is used herein to mean no elements, or if there is at least one element, the one or more elements.

By authoring is meant the addition, modification and deletion of free-text fragments and structured data objects in a composite data message. By composite data message is meant a message for reception by at least one recipient for use in activity management, that message containing both free-text and structured data, wherein text fragments are mapped to fragment data objects. By a text fragment is meant a portion of free-text, e.g., a paragraph or a sentence. According to one embodiment, a text fragment comprises one atomic unit of information for mapping to one structured data object. By a structured data object is meant a data structure, e.g., in a memory structure of known class organized into at least one data field of known type. Structured data means data organized into discrete structured data objects of known type and data fields.

An Illustrative Example

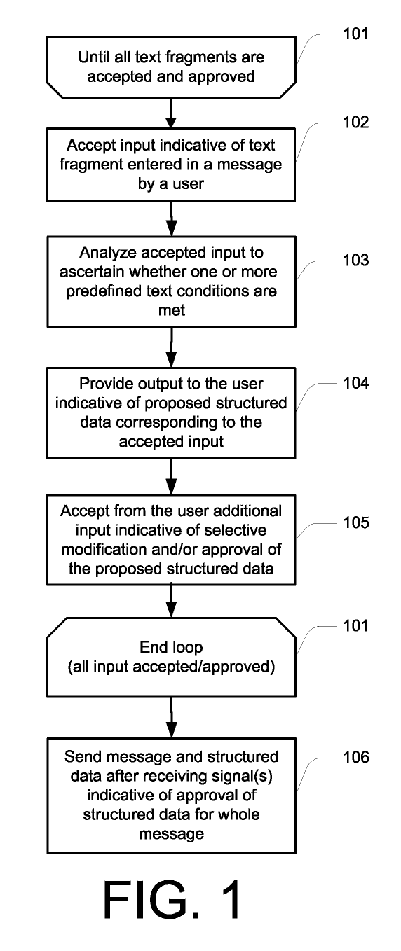

FIG. 1 provides a simplified flowchart illustrating an embodiment of the present invention in the form of a method for authoring a composite message, including providing structured data from an entered free-text message, the composite message being for receiving by one or more recipients. In one embodiment, the method is implemented on a processing system, and is part of or works in conjunction with an activity management system.

Block 101 defines the boundary of blocks 102 to 106 that are carried out incrementally in the method as more text fragments are created by the user, accepted by the method, analyzed, presented for approval or modification, and approved.

In 102, input indicative of a text fragment entered by a user is accepted. This accepted input is analyzed in 103 to ascertain whether one or more predefined text conditions are met.

104 includes in the case where one or more predefined conditions are ascertained to be met, providing to the user output indicative of proposed structured data such that the user may selectively modify, approve, or reject the proposed structured data. The term “provisional” also is used as a synonym for “proposed” to indicate that a human user has not yet approved, e.g., confirmed as correct (verified) the structured data. As described in more detail below, in one implementation, the proposed structured data includes a provisional fragment data class and a provisional fragment data object—an instance of a fragment data class. The user is thus allowed to selectively modify and or approve the proposed structured data. In 105, further input is accepted indicative of the user modifying, approving, or rejecting the proposed structured data.

102 to 105 are repeated until input corresponding to all text fragments in a message has been accepted, analyzed, and the proposed structured data corresponding to the fragments approved.

In one embodiment, the sending is in response to an explicit command to send the message, this command being provided by the user, and from this an implicit approval of the proposed structured data is inferred. For example, the user types a message including a plurality of text fragments, the proposed structured data corresponding to those fragments is incrementally optionally modified and implicitly approved as a result of one of modification and non-modification, and upon completion of the message the message is sent, resulting in implicit approval of all the proposed structured data. In another embodiment, the sending is in response to an explicit command that all text and structured data is approved.

For the purpose of the present disclosure the term “structured data” should be read broadly to generally denote data that is organized into portions having predefined purposes. For example, a given example of structured data might include a first portion identifying a person, a second portion identifying a task, and a third portion identifying a date. In some embodiments, structured data includes information that is organized into one or more discrete structured data objects, each data object having a known type. A collection of structured data object type definitions is commonly referred to as a “schema.”

A text fragment is a discernable portion of electronically created text. Among various embodiments, text fragments include paragraphs, sentences, words, or user defined portions of text. A text fragment is distinguished from a complete message for the sake of the present disclosure. Embodiments of the present invention analyze text fragments as opposed to complete messages to reduce the resources involved in analysis and to reduce the risk of analysis errors or inconsistencies. However, in some embodiments, a text fragment is an entire message, particularly in embodiments where messages are relatively short—for example in the order of one to three sentences.

Analyzing a text fragment in 103 includes one or both of analyzing the accepted input corresponding to the text fragment, and analyzing the relationship of the text fragment to one or more previously accepted inputs corresponding to the text fragments.

Proposed structured data includes proposed data and a proposed structured form. Modifying, approving, or rejecting the proposed structured data includes modifying, approving, or rejecting either or both of the proposed data and proposed structured form.

The term “created” as it relates to a message or text generally describes a message or text that is electronically prepared by a user—for example by use of a keyboard or by voice entry using a voice recognition method. In a similar vein, “text fragment entered” is text electronically written by a user to form part or the whole of the message. As used in the detailed description, authoring refers to both creating of the free-text, and forming of the structured data.

A user is a person that is capable of creating a message. In some embodiments, the user is a person creating a message via a software program adapted for the creation, editing and sending of emails or other electronic messages.

The term “message” as used herein denotes an electronic message, such as an email, an instant message as part of an instant messaging system, a mobile telephone text message such as an SMS message, and the like. Popular instant messaging systems include but are not limited to Sametime™, Qnext™, Windows Live Messenger™, AOL Instant Messenger™ (AIM), Yahoo! Messenger™, Skype™ (Chat), Google Talk™, .NET Messenger Service™, Jabber™, ICQ™, and the older (and still popular) online chat medium known as Internet Relay Chat (IRC). The message is for receiving by one or more recipients, e.g., as a result of sending by a user to the recipient(s). The recipient(s) include(s) in some embodiments, human recipient(s) identified by messaging addresses, and in some embodiments, virtual recipients such as computer programs.

The term “text conditions” refers generally to any variable aspect of text. For example, In some embodiments, text conditions include:
The presence of one or more predetermined key words. For example, one text condition is met whenever a particular predefined key word appears in text.
The presence of one or more predetermined grammatical structures. For example, one text condition is met wherever a portion of text is phrased in the imperative.
The presence of one or more predetermined grammatical or text structures. For example, one text condition is met wherever a portion of text is set out in date form.
The presence of one or more predetermined identifiers. For example, a database includes a listing of a job references for a given project, and one text condition is met whenever one of those job references appears in text. Other identifiers might be indicative of one or more resources, items, projects, persons or locations associated with a given project.
The relationship of the text fragment to one or more previously accepted inputs corresponding to text fragments, such that the analyzing of 103 includes analyzing the relationship of the text fragment to one or more previously accepted inputs corresponding to text fragments.
The presence of previously approved data types and or data in detail fields corresponding to text fragments related to the text fragment, such that the analyzing of 103 includes analyzing the data type and or data in the detail fields previously approved for text fragment related to the text fragment.

Output indicative of proposed structured data need not provide sufficient information to derive precisely the content and/or structured form of the proposed structured data. In some embodiments, the output is embodied in instructions to provide via a graphical user interface an on-screen element representative in broad and/or simple terms of the content and/or structured form of the proposed structured data. In some embodiments, the output is representative of the content and/or structured form of the proposed structured data in the sense that it provides in simple terms the context and content of the proposed structured data.

Likewise, accepting from the user additional input indicative of selective modification and/or approval of the proposed structured data need not include providing the user with all the information sufficient to derive precisely the content of the proposed structured data. In some embodiments, the user is provided with a simplified representation of the structured data by way of an on-screen element and information provided on this on-screen element is modifiable and/or approvable by the user. The user modifies and/or approves the on-screen element, and such modification and/or approval is accepted. Furthermore, approving the proposed structured data includes either or both of a preliminary inferred approval that results from a user selecting not to provide input indicative of modification, e.g., by continuing to input an additional text fragment, and a final approval. In one implementation, the final approval itself need not be an explicit approval but inferred from a command to send the message.

In some embodiments, either or both of preliminary and final approval are identified by the user pro-actively providing input indicative of a preliminary or final approval.

The approved structured data that is to be sent in one embodiment includes re-categorizing the proposed structured data as selectively modified and/or approved by the user as approved structured data. Some embodiments include creating an electronic file indicative of the approved structured data, this file being maintained in temporary memory of the processing system implementing the method.

The term “sending” as it applies to the approved structured data and the message should be read broadly to not only include pro-active sending, but also placing either or both of the approved structured data and the message in a location from where it can be sent to or obtained by the recipient or recipients. For example, in one embodiment the message is sent in that it is posted to an electronic message board, and the one or more recipients take active steps to obtain the message form that electronic message board.

While in one embodiment, the approved structured data is sent to the recipient(s), in general, the method includes any manner of providing the approved structured data for subsequent processing or storage. In some embodiments, this includes providing the structured data embedded in a signal or message, this message optionally being communicated for updating one or more records in a database. In some embodiments, such a database is provided by an activity management system. In some embodiments, the approved structured data is provided in a file indicative of the structured data, such as a plain language summary. In some embodiments, the approved structured data is provided as data embedded in, attached to or otherwise associated with the sent message such that the message is a composite message including both free text and structured data. In some embodiments, the structured data is provided by a combination of these and/or other means. The exemplary method is predominately concerned with a framework for allowing the incremental and cumulative review and approval of structured data based on text fragments created in a message. It is particularly distinguished from methods predominately concerned with complex mapping protocols for automatically translating free-text into structured data, such methods being widely known in the art.

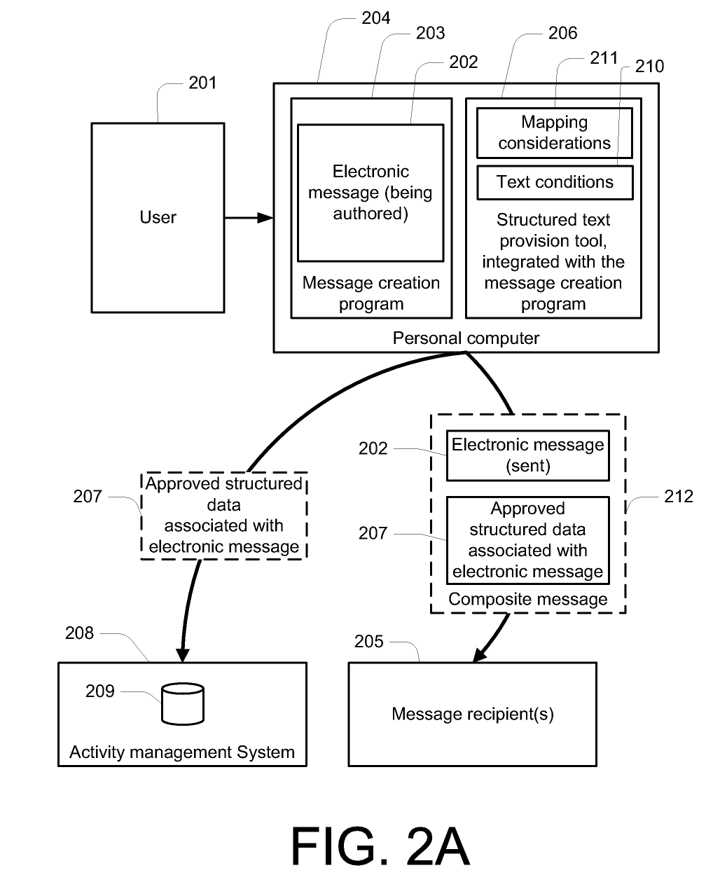

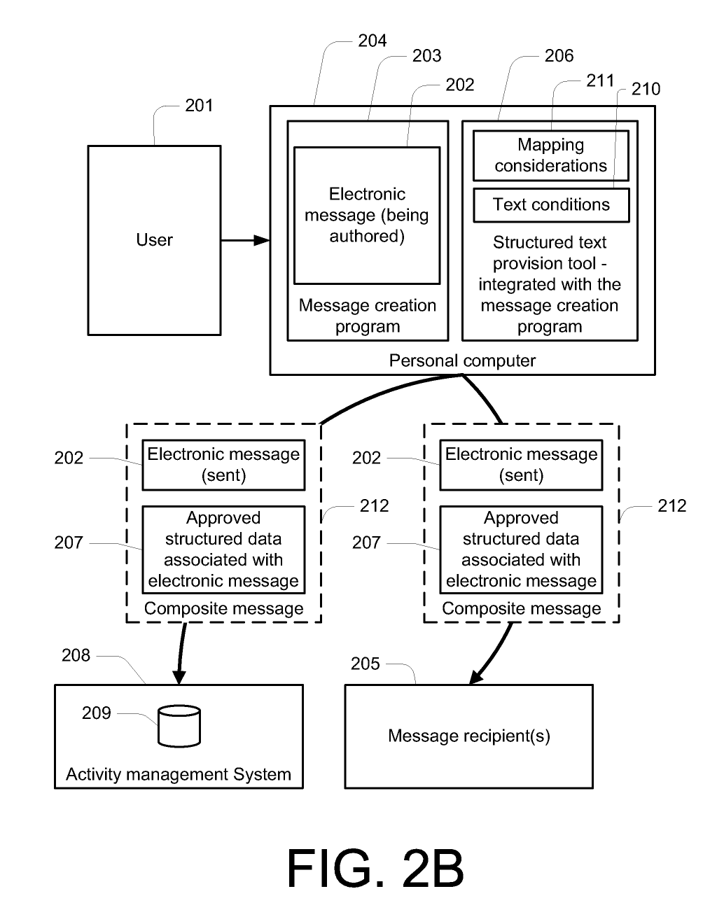

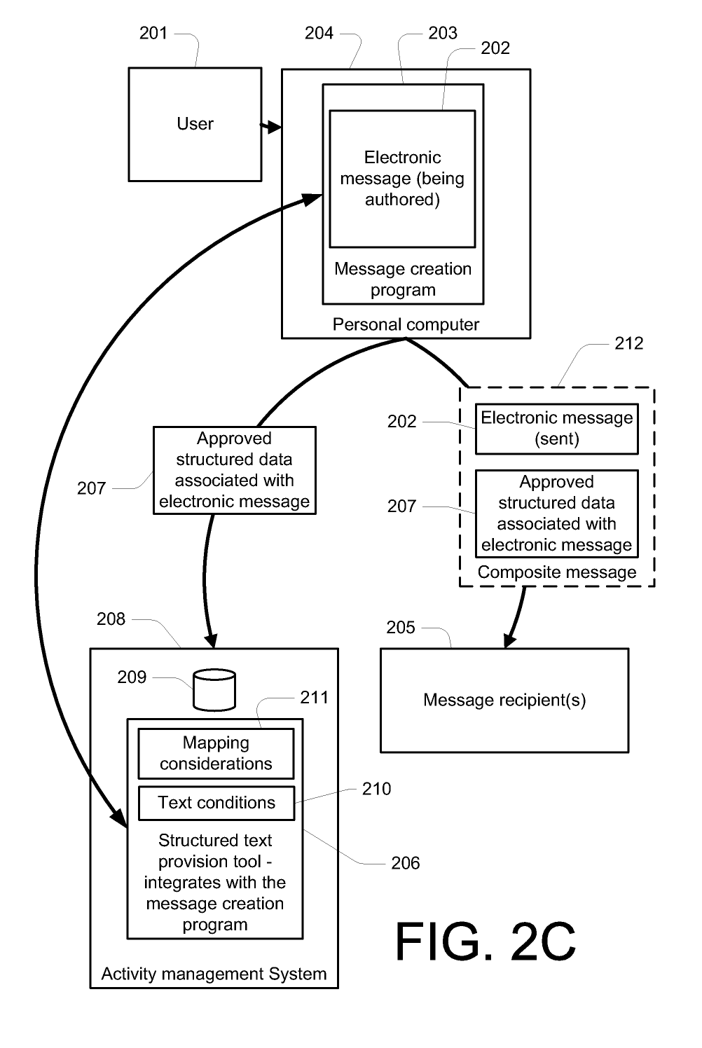

FIG. 2A shows a simplified block diagram of an exemplary system that when operating implements the method of the flow chart of FIG. 1, and further shows some of the data flow. A user 201 creates an electronic message 202, e.g., an email message by way of a message creation program 203, e.g., an email creation program running on a personal computer 204. Electronic message 202 is for sending to one or more recipients 205. User 201 authors the electronic message 202 by providing input indicative of text fragments by way of a peripheral keyboard, although in other embodiments, this input is provided by other means such as voice recognition equipment. Each text fragment input appears on a display screen of personal computer 204 as electronic text in a free-text message field provided by the message creation program 203. The process of using a keyboard and/or other functionally similar input devices to produce corresponding text in this field is generally referred to as “creating” or “writing” an electronic message.

The text fragment provided in the free text message field is free text in the sense that user 201 has the freedom to write text generally without constraint. That is, the text is written in plain language based on the personal style and tone of the user.

A structured text providing tool 206, in the form of a program on the personal computer 204 operates in conjunction with the electronic message creation program 203 for performing the method of FIG. 1. As user 201 writes message 202 text fragment by text fragment, tool 206 accepts input indicative of the text fragment being written to implement 102. In one embodiment, this is facilitated by integration between the message creation program 203 and the tool 206. In some embodiments, tool 206 is an inherent part of message creation program 203. In other embodiments, message creation program 203 is enabled to provide tool 206 data indicative of written text fragments upon predetermined conditions being met or on a periodic basis.

In some embodiments, the tool 206 and the message creation program 203 are integrated as a message authoring program, e.g., as a module of an activity management system 208, or to work in conjunction with the activity management system 208.

In some embodiments, the tool 206, and or the message creation program 203 are modules of an activity management system 208.

Although FIG. 2A shows tool 206 as being maintained on computer 204, this is by no means a requirement. In some embodiments, tool 206 is maintained on a computing platform distinct from computer 204 and in communication, e.g., via a network with computer 204. For example, in one embodiment tool 206 is maintained on one or more networked servers that maintain one or more aspects of an activity management system, e.g., as modules. In some embodiments, tool 206 includes components executed and/or maintained on computer 204 as well as additional components executed and/or maintained on other computational platforms

In one embodiment, tool 206 accepts input indicative of text fragments on a continuing basis substantially in real time. In other embodiments, the data is received upon one or more predefined conditions being met, such as the completion of a designated or identifiable text fragment, or in some cases at or about the time the electronic message is designated for sending or ready to be sent.

Tool 206 analyzes input indicative of a text fragment to ascertain whether one or more predefined text conditions are met. In one embodiment, this includes the use of a parsing engine, however alternate modes of text analysis are implemented in other embodiments.

Tool 206 is responsive to one or more of the predefined conditions being met for providing to user 201 output indicative of proposed structured data. In one embodiment, this output is provided as one or more variable and modifiable on-screen elements, as discussed further below. User 201 provides by way of these one or more on-screen elements data indicative of selective modification and/or approval of the proposed structured data.

Once proposed structured data corresponding to a completed text fragment is selectively modified or approved, user 201 commences creating of a subsequent text fragment, or alternately provides a command to send message 202. In one embodiment, tool 206 infers from the command to send message 202, an implicit approval of all structured data represented in field 202. This structured data is as such regarded as approved structured data.

In one embodiment, the approved structured data 207 is provided to an activity management system 208. Specifically, a signal indicative of data 207 is provided to an application running on system 208, that application being enabled for receiving such a signal and from that signal deriving the structured data of which the signal is indicative. System 208 is responsive to the receipt of data 207 for updating one or more records in an activity management database 209. In particular, data 207 is structured in a manner that is complementary to system 208 and database 209 such that instructions implemented in system 208 allow database 209 to be updated based on the data 207 received.

In some embodiments, system 208 includes a plurality of discrete information systems providing respective functionalities broadly associated with the concept of activity management. Moreover, in some embodiments, database 209 includes a plurality of discrete databases distributed among various platforms and/or integrated in various computer programs or systems.

As foreshadowed, although some embodiments are described by particular reference to an activity management system, it will be appreciated that other embodiments of the invention are implemented in alternate contexts. For example, in one embodiment, data 207 is provided to an electronic message monitoring system. In another embodiment, data 207 is provided to one or more of the recipients of message 202—for example as an XML or other file attached to message 202. In another embodiment, data 207 is added directly to a pre-existing file, e.g., a Microsoft Excel file, an RSS file, and so forth. In yet another embodiment, data 207 is provided to a file repository, e.g., a directory on a web server—for example as an XML file.

In one embodiment, approved structured data 207 is also provided to recipients 205 either in the body of, embedded within, attached to or otherwise associated with electronic message 202. Electronic message 202 in this way is a composite message 212, including both free text and structured data.

In some embodiments, message 202 is provided to system 208 along with data 207, as shown in FIG. 2B. That is, a copy of each electronic message authored in conjunction with tool 206 is provided to and maintained by system 208. As such, system 208 not only maintains a record of structured data provided, but also of the messages that resulted in the providing of that structured data.

In overview, user 201 author's electronic message 202 and, as part of the authoring process, tool 206 iteratively and incrementally guides user 201 through a process of approving proposed structured data. As user 201 freely creates message 202, tool 206 is responsive to free-text creating by allowing and assisting in the creation of corresponding structured data that represents the intended meaning of the message at a paragraph by paragraph level. Tool 206 provides for an interactive, incremental means by which the user is able to modify and approve proposed structured data to provide approved structured data.

In this embodiment, tool 206 looks for aspects of message 202 that are relevant to aspects of activity management in the context of system 208—primarily data indicative of activity factors. This is achieved by analysis of the electronic message text based on a set of predefined text. Using a mapping protocol, tool 206 provides user 201 with output indicative of proposed structured data. Various mapping protocols are used among various embodiments, and suitable mapping protocols will be known or may be derived from mapping protocols employed in the general field of free-text analysis.

The present approach is particularly distinguished from known approaches of free-text analysis and mapping, such approaches being primarily concerned with the accurate mapping of free text to structured data. The present approach is instead concerned with providing a convenient interface for guiding user 201 through the structured data creation process in a time effective and user-friendly manner.

Data indicative of predefined text conditions 210 are associated with a plurality of structured data types in a repository of mapping considerations 211. A “data type” is in a broad sense a type of information that is able to be represented as structured data. There is a wide range of possible data types that are implemented among embodiments, and one common example that will be particularly considered herein for the sake of explanation is a “task.” A “task” is a data type that describes an activity that is to be completed by a particular person in a given timeframe. Other possible data types include risks, mitigations, and salutations.

Although FIG. 2A shows text conditions 210 and mapping considerations 211 as being maintained on computer 204, In other embodiments, either or both of these are maintained on a platform remote of computer 204. In some embodiments, either or both of text conditions 210 and mapping considerations 211 are maintained on a central server in communication with computer 204 via the Internet, a local area network or a wide area network. In one embodiment, both are maintained on one or more platforms provided by system 208, as shown in FIG. 2C. In FIG. 2C tool 206 along with text conditions 210 and mapping considerations 211 are maintained remotely of computer 204 as part of system 208. Program 203 interacts with tool 206 over the Internet. In some such embodiments, portions of the code embodying tool 206 are temporarily or semi-permanently downloaded to the memory of computer 204.

The precise manner of association of text conditions to data types varies between embodiments, and is in some embodiments, implementation environment specific. For example, a given key word might have different meanings in different environments. For example, in a computer program development environment the term “bug” might be associated with a data type relating to system problems. In an automotive environment, on the other hand, the term “bug” might denote a type of vehicle. In some embodiments, tool 206 provides a framework for the association of text conditions to structured data types to allow for environment specific implementation. In other embodiments, standard relationships are defined and supplied with tool 206 at the time of purchase by a consumer.

Each data type is indicative of one or more detail fields, and the output indicative of proposed structured data provides one or more of the detail fields of which the structured data types included in the proposed structured data are indicative. These detail fields are for maintaining structured data details relevant to aspects of a particular data type. Providing additional input indicative of selective modification and/or modification of the proposed structured data includes editing and/or approving information contained in the provided detail fields. This is discussed further below.

Taking the example of a task, for the examples described herein a task is indicative of a plurality of detail fields including the following:
A task identifier, identifying the task such that one task might be distinguished from another task. In some embodiments, a user defines a task identifier. In some embodiments, task identifiers are automatically assigned in accordance with an assignment protocol, and in some embodiments, a combination of these approaches is used.
A task type or classification. This identifies the type of task. In some embodiments, being selected form a predefined list of task types. For example: “problem resolutions,” “enquiry responses,” “stock ordering,” and so on—these vary among embodiments depending on the environment in which the system is implemented.
A task completion date. This identifies a date by which the task is to be completed.
A task performer. This identifies a person allocated to perform the task, or at least allocated to be responsible for performance of the task.
A task priority. This identifies the relative importance of the task based on a set of predefined priority tiers including low, medium and high.

Other possible detail fields include deadlines or other dates, resource allocations, priority rankings in a broad sense, responsibility allocations in a broad sense, and task acceptances or rejections. As is the case with data types, detail fields for each data types are, in some embodiments, defined in an environment specific fashion. For example, in some embodiments, “task” is associated with an additional detail field relating to the budget on which a task is to be performed. In other embodiments, tasks are associated with other detail fields that, in the implementation environment of those embodiments, represent relevant activity data for a task.

In one embodiment, tool 206 is responsive to the text conditions and mapping considerations for identifying one or more possible data types. In such a case, tool 206 provides output indicative of one or more of the identified possible task data types and the related detail fields. In some embodiments, the detail fields are provided for completion by user 201, however in the present preferred embodiment tool 206 seeks to automatically populate information in the detail fields based on analysis of the text and thereby to reduce the effort required on the part of the user.

As noted above, detailed aspects of mapping are not fundamental to embodiments of the present invention. In simple terms, the mapping protocols of various embodiments analyze one or more structured data types that are identified based on text conditions that are met. From this, a preferred selection of data types is identified—that is, the group of possible data types is narrowed to provide a preferred selection by applying a selection protocol. From this preferred selection one or more most likely candidates are identified, and one or more of these are in the first instance included in the proposed structured data. To assist in this goal, the selection protocol in some embodiments, includes one or more of the following:
A confidence level assessment. Confidence level assessments are known in the art of free-text mapping, and discussed in more detail further below.
Analysis of one or more attributes associated with the user. For example, information relating to user 201, including information maintained by system 208. This information includes details of activities in which and persons with whom user 201 is involved, and assists in placing additional context on the text of message 201.
Analysis of one or more attributes associated with one or more of the recipients. This is similar to the above example, however the attributed of one or more of the recipients are instead considered. Suppose, for example, that the recipient of the message holds the role “Operational Risk Officer,” and of the identified possible data types for a given text fragment, one is “Risk.” Then, in one embodiment, the selection protocol selects “Risk” as the preferred data type.
Analysis of one or more relationship attributes relating to the user and one or more of the recipients. For example, information relating to the joint activities of the user 201 and the one or more recipients of the message maintained by system 208.
A comparative assessment of degree to which the detail fields of each identified data type can be automatically populated. In one implementation, the most preferable data type is the data type for which the greatest number of detail fields can be populated automatically.
Analysis of one or more attributes associated with a related message. A related message is, in some embodiments, a message sent in a common message chain. For example, a second message is related to a first message where that second message is a reply to the first message, or a forwarding of the first message. Attributes associated with related messages allow the mapping protocol to take into consideration factors relevant to message workflows.
Assessment of previously approved structured data. Structured data approved in previous messages often leads in a logical fashion to subsequent structured data. For example, where a second electronic message is a reply to a first electronic message, approved structured data associated with the first electronic message is likely to have a bearing on proposed structured data for the second electronic message.
Application of data derived by a learning algorithm. In some embodiments, tool 206 learns over time based on experience. For example, additional key words and sentence structures are learned. In some embodiments, the learning affects apply to multiple users, in other embodiments the learning effects are user-specific such that tool 206 grows accustomed to the writing style of a particular user.

The role of mapping in one embodiment is not necessarily to provide proposed structured data with ultimate accuracy. The need for accuracy in mapping is counteracted by the approach of providing proposed structured data, and allowing a user to selectively and conveniently modify the proposed structured data and in doing so account for mapping inaccuracies. That being said, accurate mapping is helpful and beneficial in that it reduces the time and effort required on the part of user 201 to review and approve structured data, and correspondingly improve user perceptions of the system as a whole.

In one embodiment, output indicative of proposed structured data is performed upon the completion of a text fragment by a user, in one embodiment being a paragraph. In a practical sense, in such an embodiment a text fragment is delineated by the pressing of the “enter” key on a conventional keyboard. The rationale for the present approach of using text fragments in the form of paragraphs is that, generally speaking, message creators use different paragraphs to address different issues.

It will be appreciated that in some embodiments, text fragments are delineated differently from the delineation described above. For example, in one embodiment, the input corresponding to a discrete text fragment is considered complete when all detail fields of the proposed data type have been populated.

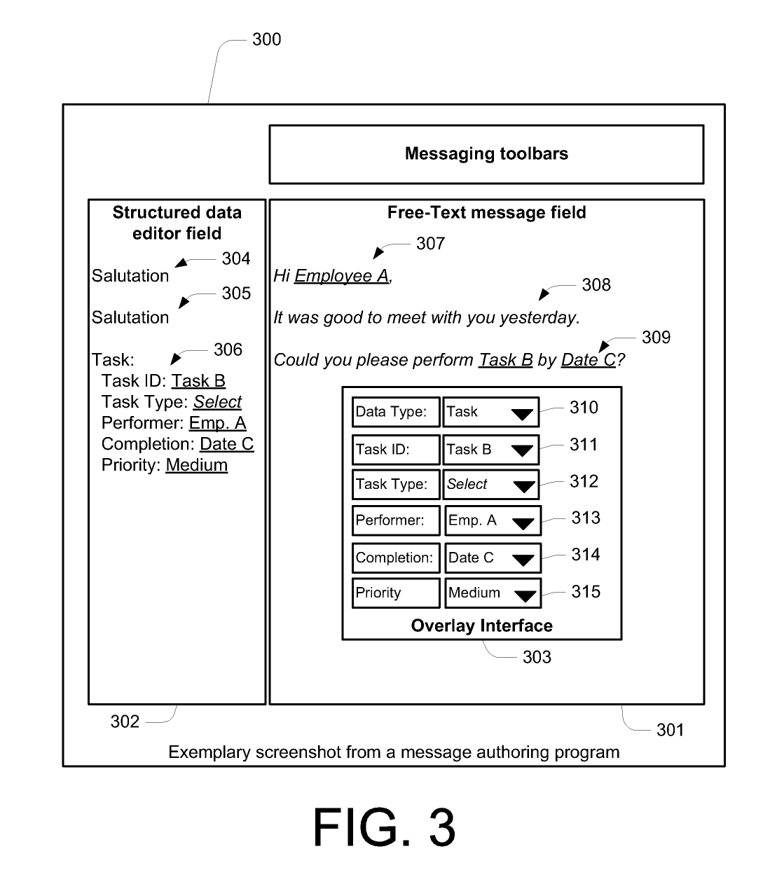

FIG. 3 provides a schematic representation of an exemplary screenshot 300 provided by a graphical user interface on computer 204 through or in conjunction with program 203, e.g., as part of a message authoring program that integrates tool 206 and message creation program 203. This screenshot illustrates in the context of FIG. 2A an example of output indicative of proposed structured data. In this example the output is provided by way of a plurality of variable and modifiable on-screen elements that represent the context and content of the proposed structured data.

Screenshots provided herein should not be regarded as limiting, and are provided for the sake of example only. In other embodiments, graphical user interfaces are adapted to provide the same general functionalities whilst including aesthetically different screens and different on-screen elements.

User 201 authors message 202 by electronically writing free-text in a free-text message field 301. As free text is received, it is accepted by tool 206 as input indicative of a text fragment. As mentioned above, a text fragment in one embodiment is a paragraph of text.

In one embodiment, output indicative of proposed structured data is provided by two primary on-screen elements: a structured data editor field 302 and a structured data overlay interface 303. In other embodiments, only one of these elements is used, and in some embodiments, various other elements are used such as elements known to those familiar with the use and design of graphical user interfaces. It will be appreciated on the basis of the description below that the present combination approach is advantageous in directing a user to carry out ongoing, incremental and iterative modification whilst still providing means for overall review.

In one embodiment, output indicative of proposed structured data is provided by two approaches: a structured data editor field 302 and a structured data overlay interface 303. In other embodiments, only one of these approaches is used, and in some embodiments, alternate approaches are used. It will be appreciated on the basis of the description below that the present combination approach is advantageous in directing a user to carry out ongoing modification whilst still providing means for overall review.

Field 302 provides a summary representative of proposed structured data. This summary includes listed entries 304 to 306 horizontally aligned with corresponding text fragments—in one embodiment horizontally aligned with the first lines of corresponding paragraphs 307 to 309. Each listed entry is indicative of a data type, the detail fields for that data type, and information maintained in those detail fields. User 201 is therefore conveniently able to correlate a particular paragraph with the proposed structured data associated with that paragraph. For example, user 201 easily sees that entry 304 corresponds to paragraph 307.

In some embodiments, the listed entries are provided in the form of one or more tree diagrams, the tree diagrams having leaves corresponding to detail fields for each data type.

In this example paragraphs 307 and 308 respectively read “Hi Employee A,” and “It was good to meet with you yesterday.” Employee A is an exemplary recipient considered for the sake of this example. These paragraphs have been identified as salutations based on the implemented mapping protocol, and proposed structured data of the data type “salutation” is provided and represented in entries 304 and 305 respectively. User 201 is able to modify these entries by, for example, clicking on them using a mouse pointer and selecting from various menu options. This is performed in instances where, for example, a paragraph is incorrectly identified as a salutation.

Input indicative of the text fragment under creation is accepted as input by tool 206, and this input is analyzed to ascertain whether text conditions are met. Upon completion of a text fragment, output indicative of proposed structured data is provided via field 302 and overlay 303.

In some embodiments, the overlay interface is only provided in certain cases. For example, in one embodiment the overlay interface is not provided following a text fragment identified to be a salutation, or in some cases following a text fragment identified to be a salutation where that text fragment is the first paragraph in a message. In some embodiments, the overlay interface is a feature that is optionally disabled pursuant to a user command. In one embodiment, the overlay is provided only for text fragments for which the mapping protocol does not produce and unambiguous proposed structured data mapping.

At the moment illustrated in FIG. 3, user 201 has just completed creating paragraph 309, which reads: “Could you please perform Task B by Date C?” where Task B and Date C are an exemplary task and date. Upon pressing the enter key at the completion of this paragraph tool 206 provides overlay interface 303, this interface providing information representative of a data type and associated detail fields as modifiable items superimposed on free-text message field 301. In this example tool 206, based on the mapping protocol, selects the data type for this paragraph to be a task—for example based on the question sentence structure and the key word “perform,” or alternately based on the key phrase “can you perform.” Tool 206 also recognizes that the message is for sending to Employee A and that the date is Date C.

Interface 303 in this example provides:
A modifiable data type field 310 identifying the data type of “task.”
Modifiable detail fields 311 to 315 relating respectively to the task identifier, task type, task performer, task completion date and task priority.

Of these detail fields, fields 311, 313 and 314 are pre-populated with “Task B,” “Employee A” and “Date C” respectively, this representing proposed structured data identified based on the mapping protocol and analysis during phase 102. In some embodiments, field 312 is also pre-populated based on the mapping protocol—for example where the actual literal description of Task B (or other text in message 202) indicates what Task B is about. For example, if Task B were actually to read “provide an updated costing summary” the task type might be “accounting.” In one embodiment, field 315 is by default populated with priority tier “medium,” which is subject to change. A priority tier of “high” might be assigned following the presence of a key word such as “urgently.”

In one embodiment, fields 310 to 315 are modifiable in two ways:
Using an expandable menu arrangement, in this case a pull-down menu. If user 201 wishes to modify the content of any of these fields, the user clicks an icon to access alternate choices, and optionally selects from the alternate choices. For example, alternate choices for field 310 include alternate data types.
Manually entering text, achieved by clicking on the relevant field and using the computer keyboard.

Alternate choices provided by the expandable menus are in one embodiment prioritized. In the example of field 313, the alternate choices include close matches identified by tool 206—for example other employees referred to in the text of message 202. Consider an example where paragraph 309 reads “Could you please have Employee D perform Task B by Date C?” Assume, for the sake of example, that field 313 still reads “Employee A” based on a mapping protocol assumption that for a task the task performer is most likely to be the electronic message recipient. Assume further that the mapping protocol determines that the next most likely task performer is a possible task performer mentioned in the text of the paragraph under consideration. In such a case field 313 is pre-populated with “Employee A,” and “Employee D” is provided as a high priority alternative. In practice user 201 modifies field 313 to read “Employee D,” and in doing so the proposed structured data is modified.

It will be again appreciated that the purpose of mapping protocol in one embodiment is not to necessarily with maximum accuracy identify data types and pre-populate detail fields, but instead to make a best guess and in doing so reduce the amount of time and effort required on the part of user 201. User 201 is presented with best guesses, and modifies aspects of those guesses that require modification. The approach implemented via the method of FIG. 1 to a degree makes less critical the accuracy of a mapping protocol by providing a user friendly, time effective and intuitive interface for allowing the modification of proposed structured data.

Once user 201 is satisfied with the information presented in overlay interface 303, the user again hits the enter key. In one embodiment this is regarded as approval of the proposed structured data. According to some other embodiments, this is not regarded as approval of the proposed structured data, yet is regarded as a form of provisional approval. In one embodiment, approval is only provided if and once user 201 provides a command to send message 202.

In one embodiment, changes to a text fragment subsequent to the approval of the corresponding structured data revoke the approved status of the corresponding structured data, such that the structured data is again considered provisional. Another embodiment includes providing for the user the capability of manually revoking the approved status of previously approved structured data.

In one embodiment, it is not necessary to fill out all of the provided detail fields. For example, field 312 of FIG. 3 is left blank (which is represented by the term “select”). One or more detail fields can be left blank or modified to be blank without affecting the user's ability to send an electronic message. In this way tool 206 does not prescribe the information that must be provided, but instead draws to the attention of user 201 the type of information that would be helpful or relevant in the contact of system 208. In other embodiments, tool 206 is prescriptive and will not allow an electronic message to be sent unless all detail fields are completed. It will be appreciated that selecting a level of prescriptiveness involves balancing considerations of obtaining all relevant data and reducing the invasiveness of tool 206 on everyday electronic message communications.

In some embodiments, data types are related to further data types. For example, in some embodiments, tool 206 is responsive to certain text conditions for identifying a data type in the form of a “problem” which is related to a second data type “resolution.” The “problem” data type is identified, for example, where the text in electronic message 202 includes key words such as “bug” or “crash” in an information technology environment, or where the text in electronic message 202 includes key words such as “allegations” or “breach” in a commercial environment. When providing proposed data including the “problem” data type, field 302 and interface 303 provide the detail fields for the problem data type, which might be “problem identifier” “problem type,” “severity,” and so on.

As for the second data type, “resolution,” a resolution is a similar to a task. “Resolution” might be indicative of detail fields such as “responsible employee” and “resolution deadline,” and is indicative of the problem identifier for the problem to which the resolution relates.

In some embodiments, when a “problem” is identified tool 206 not only suggests user 201 complete/modify/approve detail fields for the problem, but also suggests user 201 complete/modify/approve detail fields for a resolution to that problem. In some cases a single paragraph of text includes sufficient information to allow tool 206 to pre-populate detail fields for both the problem and the resolution.

In some embodiments, a user chooses not to complete/modify/approve detail fields for a resolution at the time of completing a paragraph relating to a problem. In cases where the user deals with a proposed strategy for resolution in a later paragraph, the relevant detail fields are at the completion of that paragraph again provided by way of field 302 and interface 303, with detail fields pre-populated based on text provided. The detail field for the problem identifier is, in some embodiments, by default pre-populated for the problem identifier of the most recently identified problem.

In some embodiments, relationships between data types are used by the mapping protocol. Using the above example for context, in one embodiment when analyzing input from a given text fragment, the mapping protocol gives higher priority to data types related to data types in recently proposed structured data.

When user 201 is finished creating electronic message 202, that user is able to quickly and conveniently review the proposed structured data via field 302. Modifications are easily made in field 302, and furthermore field 302 shows where detail fields were suggested but not completed. User 201 optionally completes these fields, the intention again is not to be prescriptive but rather to draw the attention of user 201 to the information that might be relevant.

Once user 201 is satisfied with the information shown in field 302, and the text content of message 202, the user provides a command to send the message to recipients 205. Responsive to this command, the proposed structured data identified in field 302 is defined to be approved structured data 207, and message 202 is sent to recipients 205. As foreshadowed, a signal indicative of data 207 is provided to system 208, and to recipients 205 as data associated with electronic message 202.

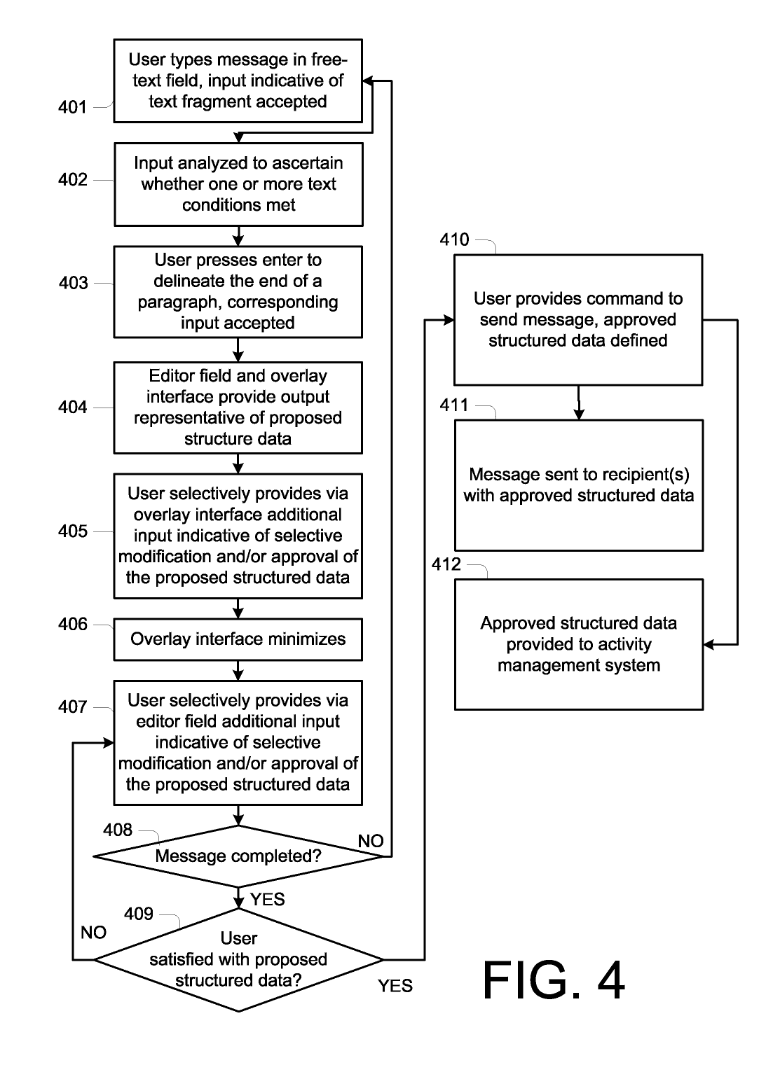

The flowchart of FIG. 4 provides an overview of the method described above. In 401, user 201 freely types message 202 in field 301, and input indicative of a text fragment—in one embodiment being a paragraph—is received by tool 206. Tool 206 analyzes this accepted input at 402 to ascertain whether one or more of the predefined text conditions are met. In 403 user 201 presses the enter key to delineate the end of the paragraph, and this is received as input by tool 206. In 404, tool 206 provides by way of field 302 and interface 303 output of proposed structured data corresponding to the completed paragraph. In 405, user 201 optionally provides additional input indicative of selective modification and/or approval of the proposed structured data. In particular, modification is achieved by editing the information in detail fields displayed by interface 303. Approval is inferred by user 201 providing a command to minimize interface 303—in this case provided by an additional press of the enter key. In 406 the overlay interface minimizes, however user 201 remains at liberty to further modify the structured text corresponding to the completed paragraph using field 302 in 407. Where such modification is carried out, tool 206 receives further additional input indicative of selective modification and/or approval of the proposed structured data.

In 408 it is considered whether the message is completed—this corresponding to whether all text fragments for inclusion in the massage have been accepted. It will be appreciated that where the message is not completed the method cycles to 401 as a subsequent paragraph is commenced. In that case, in one embodiment, the iterative technique of structured data proposal and approval continues, and repeats until the message is completed.

In 409 it is considered whether the user is satisfied with the proposed structured data. It is assumed that, if the user is not satisfied, the user will further modify the structured data corresponding to one or more of the completed paragraphs using field 302 in 407. If the message is completed and the user is satisfied with the proposed structured data, the user provides a command to send the message at 410. Message 202 and structured data 207 are provided to recipients 205 at 411, and data 207 provided to system 208 at 412.

As foreshadowed, in some embodiments, each message associated with approved structured data is provided to system 208.

One underlying rationale behind providing structured data 207 to recipients 205 is to assist in analysis of free text created by one or more of recipients 205 in an electronic message reply to user 201 based on electronic message 202. Continuing with the example above, assume Employee A receives a completed version of the electronic message shown in FIG. 3. Employee A replies to this electronic message using an electronic message program integrated with a tool substantially identical to or complementary with tool 206. That tool is responsive to the received data 207 for applying mapping considerations. In this example, the tool expects to find in the text of the reply message either an acceptance of Task B or a rejection of Task B, and proposed structured data is provided accordingly once appropriate text conditions are found. For example, the presence of a key word “OK.” An acceptance might also include detail fields such as “estimated time of completion,” whilst a rejection might also include detail fields such as “reason for rejection” and “suggested alternate task performer.”

Assuming this reply electronic message is sent and includes an acceptance, the resulting structured data is provided to system 208 (and user 201). In such an event, system 208 maintains data indicating of a task that has been assigned, and data indicating that the task has been taken on. A project manager can use this information to chase Employee A where the assigned Task B has not been completed by Date C. In some embodiments, system 201 provides automatic reminders in a similar vein. In one embodiment, where user 201 assigns a task and that task is either not accepted within a predetermined timeframe or alternately rejected, the system provides an automated notification in the form of an electronic message to user 201 suggesting that user 201 re-assign the task or follow up with Employee A.

It will be appreciated that a multitude of programs, tools and utilities might be implemented in conjunction with system 208 to make use of structured data provided by tool 206 and assist in activity management. These generally fall beyond the scope of the present disclosure.

In some embodiments, message templates are used. In particular, when authoring message 202, user 201 selects a template to, among other things, assist in the application of the selection protocol. For example, templates relate to particular types of messages, and the selection of a template affects how text fragments in a message authored under that template are analyzed. These message templates are different from the templates mentioned in the Background section as used in prior art systems, in which a user selects a template and is then provided with, e.g., displayed fields according to the selected template, so that the user can provide data for the provided fields. Such prior art use of templates is similar to prior art use of forms.

In some embodiments, there is a pre-defined default message template, such that, if the user elects not to select a specific template, the default template is assigned.

In one embodiment, to assist and enhance the accuracy of the selection protocol, a message template includes data indicative of at least one of:
One or more schemas.
The data types likely to occur in messages according to the template.
The successions of data types likely to occur in messages according to the template.
Other relationships between data types likely to occur in messages according on the template.

In one embodiment, when selecting a preferred data type for a text fragment, the selection protocol gives preference to a data type identified as a likely data type for messages according to the template in effect for the current message. In another embodiment, a message template provides further information to indicate the relative likelihood of the occurrence of each data type in messages according to the template.

Furthermore, in one embodiment, such a message template defines none or more compulsory data conditions for messages according to the template. For example, a template defines one or more data types as mandatory for messages according to the template, and the user 201 is prevented from sending such a message as long as at least one mandatory data type does not exist in the approved structured data of the message created under the template. According to another example, a succession between a first and a second data type is designated to be a compulsory succession, such that the user 201 is prevented from sending a message created under the template wherein the structured data comprises the first data type of the compulsory succession but not the second.

In one embodiment, such a template optionally defines one or more pre-formatted text fragments and the corresponding structured data indicative of the desirable and or mandatory contents of messages according to the template, thereby reducing the amount of data entry required of the user 201 and enhancing standardization of communication.

In some embodiments, templates further provide pre-determined automated behaviors, for example macros, the behaviors for executing in response to one or more predefined triggering conditions in messages.

In one embodiment, each message template defines none or more pre-determined stages and none or more possible sequences of stages for the message and for subsequent related messages. Further, for each stage of the message, the template defines none or more likely data types and/or behaviors and/or validity conditions. This defines what is called a workflow for the message and related messages as a whole. An underlying rationale is that each time the message is forwarded it progresses to another stage. At each stage it is possible to enforce that certain validity conditions are met, for example to guide, track and control the workflows.

In some embodiments, tool 206 is adapted to manage information lifecycles. In one embodiment each data type is associated with none or more allowed lifecycle stages, and each such stage is associated with none or more allowable succession states. In one example, a text fragment defines a “Task” data type. For tasks, the information lifecycle includes stages such as “Logged,” “Scheduled,” “Progressing,” “Under Review,” and “Finished.” Further, each stage is associated with none or more detail fields and validity conditions. For example, a “Due Date” detail field for a “Task” is not mandatory when the task is at stage “Logged,” but it is mandatory and must contain a valid date once the task is progressed to stage “Scheduled” and every subsequent stage following “Scheduled.”

As an example of the use of lifecycles, in one embodiment, a user replying to and/or forwarding a composite data message is able to modify the detail fields so the lifecycle governs to which stage the user is allowed to progress a particular data fragment, based on its current stage, and optionally based on other validity conditions. For example, a “Resolution Action” can only be marked as “Finished” if a corresponding “Resolution Outcome” detail field has been populated.

According to another aspect of the invention, the tool 206 uses one or both of the workflow stage of the message and the lifecycle stage of individual data fragments to determine one or both of:
The detail fields of each data type that are currently for display to the user.
The detail fields of each data type that that are currently modifiable by the user.

In one embodiment, determining which detail fields to display to the user 201, and/or determining which of the displayed detail fields to make modifiable to the user includes using one or more of:
The security profile of the user.
The role of the user in relation to the environment, e.g., the user's role in the company in the case of a company.
The role of the user in relation to the workflow stage of the message.

In one embodiment one of recipients 205 creates a further message related to message 202, such as a reply message or forward message. In one embodiment a message reception and creation program used by this recipient is integrated with a tool complementary with tool 206, and this tool is responsive to the data 207 associated with message 202 for providing to recipient 205 a related response message. In one embodiment this tool determines the likely constituent text fragments and structured data for a response to message 202, by considering indicators including, one or more of:
The data types of individual data fragments in message 202.
The workflow stage of message 202.
The lifecycle stages of individual data fragments in message 202.

In one embodiment, after determining the likely constituent text fragments and structured data, tool 106 provides the responding recipient 205 with a related response message, and populates the message with the determined text fragments and structured data. Suppose, for example, that the message 202 includes a “Question” data type. In the example, the provided response message is populated with a copy of the free-text and the structured data of the original message 202, and additionally with a data fragment of type “Answer” and a corresponding text fragment consisting of a visually delineated blank line for population by the user. The text fragment is provided adjacent to the copy of the text fragment corresponding to the “Question” of the original message 202. Using these aspects, such an approach for example can guide a recipient through the process of addressing issues raised in previous emails towards a goal of providing relevant structured data. The remainder of the message creation proceeds substantially in the same manner as message 202 was authored.

Although in the above example proposed structured data is provided responsive to the completion of a paragraph in electronic message 202, in some embodiments, proposed structured data is provided at the completion of alternate text fragments, alternate times and/or upon one or more predetermined conditions being met. These predetermined conditions include might include:
A user input, for example a user input requesting that proposed structured data be provided. In such a case the user has additional control over the definition of a text fragment—a text fragment is defined by virtue of a user command indicating that a text fragment has been completed.
Input indicative of message completion. For example: a command to send the message. In one embodiment, this operates similarly to a pre-send spell check functionality—between a “send” command being provided and the message actually being sent, tool 206 provides proposed structured data for review and selective modification/approval by user 201.

It will be appreciated that, over time, users become accustomed to the operation of tool 206 and learn to subtly adapt their own writing styles to streamline the process of structured data creation. It is envisaged for a given user, over time, mapping accuracy will increase and the amount of time spent reviewing proposed structured data will correspondingly decrease—without the need to necessarily make changes to mapping protocols implemented. In this way, effectiveness of some embodiments of the present invention hinges on the general process shown in FIG. 1, as opposed to aspects of mapping accuracy.

To further streamline this process, in one embodiment, the tool 206 determines and signals to the user the proposed structured data, wherever possible, ahead of the creation of the text fragment corresponding to that structured data. For example, suppose a predefined succession relationship exists between a first and a second data type, and the user 201 is about to create a new text fragment following a preceding text fragment, where the structured data corresponding to the preceding text fragment is of the first data type. To continue with the example, one embodiment of the tool 206 determines that the new text fragment, according to the predefined succession, is likely to be of the second data type, and accordingly updates the structured data editor field 302. Thus the user is guided as to the desirable informational contents for the new text fragment.

In another embodiment, such predefined succession relationships are selectively designated as mandatory. For example, suppose a company has designated as mandatory the succession between the data type “Business Issue” and the data type “Resolution Action”. In this case the user 201 is prevented from sending a message comprising any text fragment identified to correspond to a “Business Issue” unless the structured data of the immediately following each such text fragment is of type “Resolution Action”.

In one embodiment, the text conditions that were instrumental in determining the proposed structured data are temporarily indicated to the user. For example, the tool 206 indicates the keywords used to determine the data type for a given text fragment by temporarily highlighting those keywords in the free-text message field 301.

Although the above embodiments have been particularly described by reference to electronic message, other forms of electronic free-text messaging methods are used in some embodiments. By electronic message what is meant email, instant messages, and other forms of messaging that is in electronic form and electronically deliverable to the one or more recipients. Free-text messaging methods include email methods, e.g., using Microsoft Outlook (™) software, and using instant messaging software, e.g., AOL Instant Messenger (™). Such free-text methods typically treat the body of the message as a single unit that includes a series of text characters, and do not impose a structure on the contents of the message. Thus, the user is free to determine the format, length, degree of detail, tone of voice, terms used and other such aspects of the communication.

Further Detailed Description

Additional description of embodiments and examples is provided herein below.

The following glossary of terms is provided for guidance in relation to these embodiments and examples.
Active fragment data object: The fragment data object corresponding to the active text fragment.
Active text fragment: The text fragment currently being authored by the user.
Active: Refers to the current state of an entity, e.g., a fragment data object or a text fragment. An entity is active if it is currently selected for modification.
Authoring: The addition, modification and deletion of free-text fragments and structured data objects in a composite data message.
Automatic: Refers to an aspect of an operation, the aspect being that the operation is performed by a method without manual intervention necessary.
Class: A static definition specifying the structure for all structured data objects based on that class. Typically, each such definition includes specifications for at least one data field definition, and optionally includes: validation rules, behavior definitions, and relationship definitions. Those skilled in the art will appreciate that a class is equivalent to the “class” concept in object-oriented design.
Click-and-drag: A manual operation performed using an indirect pointing device, e.g., a mouse, such that an on-screen element is moved to a new location.
Activity management: The activities and processes involved in the managing activities, risks, and/or issues by providing information that relates to these activities, risks, and/or issues, and for processing this information. Such managing include, for example, planning, executing, controlling, evaluating and reporting of human collaborative undertakings.
Composite data message: A message for reception by at least one recipient for use in activity management, that message containing both free-text and structured data, wherein text fragments are mapped to fragment data objects.
Containment relationship: A relationship between two fragment data objects, wherein the first (the “Container”) includes the second (the “Containee”).
Data field: A permanent and/or temporary memory structure able to store a value. In some cases a data field can hold only values of a specified type.
Expected relationship: A relationship in accordance with a specific relationship definition.
Fragment data class: A class of structured data objects, the data objects for mapping text fragments.
Fragment data object: An instance of a fragment data class.
Free-text: Text is not organized into structured data objects. In some cases free-text does contain formatting mark-up.
Instance: A specific exemplar of a given type, e.g., a structured data object based on a given class, a solution tuple of a given relation, or a record in a database table.
Lifecycle: A sequence of optional and/or mandatory transitions between stages applying to a fragment data object, a data field or a relationship. In one embodiment, a lifecycle also comprises none or more conditional branches and none or more conditional repetitions in the transition sequence.
Manual: Refers to an aspect of an operation, the aspect being that the operation is performed by a human user.
Mapping accuracy: The degree of accuracy to which the class and data field values of a given fragment data object and the relationships of the fragment data object with other fragment data objects represent the semantic content of the text fragment associated with that fragment data object, i.e., the degree to which the mapping method produced the results intended by the user.
Mapping aid: A support, e.g., a plurality of data, for use by an embodiment of a mapping method.
Mapping confidence level: The level of confidence that a particular mapping decision will maximize mapping accuracy.
Mapping consideration: A factor contributing to the outcome of a mapping decision.
Mapping constraint: A rule specifying a limitation on a mapping process, for example, one mapping constraint specifies that a particular mapping process can only be performed at a particular stage of a defined workflow.
Mapping decision: an operation performed by one method embodiment as part of a mapping operation, resulting in the selection of one particular outcome from an at least one possible outcomes, e.g., the selection of a provisional fragment data class.
Mapping target: The structured data entity currently being instantiated and/or populated with values as part of a mapping operation. The types of structured data entities that can serve as mapping targets include: fragment data objects; data fields of fragment data objects; relationships; and data fields of relationships.
Mapping: An operation performed on a text fragment to convert the free-text of the text fragment to structured data resulting in: (a) the creation and/or modification of at least one fragment data object corresponding to the text fragment; (b) the assignment of values to none or more data fields of the at least one fragment data object; and (c) the creation and/or modification of none or more relationships between fragment data objects. Preferably, the operation is performed so as to maximize mapping accuracy.
Message template: A pre-defined standard on which a composite data message is based.
None or more: In the description and claims, the term “none or more” for a quantity of elements means either none of the elements, or if there is or are elements, at least one element.
Property page: A method/mechanism for displaying the names and current values of data fields of a structured data object, and for providing a mechanism for the manual setting and changing of the values. According to one embodiment, this also includes providing for the selection of a new fragment data class for creating a new structured data object according to that new class.
Provisional: Refers the status of an entity, e.g., a class, a structured data object, or a data field, where the identity and/or data state of that entity has not been manually confirmed as correct by a human user. The term proposed also is used.
Reference: Any mechanism for locating and accessing a specific entity, including, for example: Pointers; C++ and Java references; Positional offsets; and Indexes.
Relationship definition: A definition for a relationship expected to exist between instances of the first and second class specified in the relationship definition. In some cases the first and second class specified in the relationship definition is the same class. According to one embodiment, relationship definitions can exist in a schema and in a message template. According to one embodiment the relationship definition further includes none or more validation rules and mapping constraints.
Relationship: Refers to a bi-directional association between two structured data objects, e.g., a tuple of references (such as pointers) to structured data objects in RAM, or a foreign key value in a relational database.
Satisfy: To meet a required set of conditions, for example, a structured data object satisfies a class if the structured data object is an instance of that class or is an instance of a direct or indirect specialization of that class.
Schema: A set of definitions from which instances can be created. Typically, a schema includes: at least one class; none or more relationship definitions; none or more mapping aids; and none or more mapping constraints.
Semantic content: The meaning(s) of a given free-text as intended by the author of that free-text.
Specialization: A relationship between two classes, wherein one class (the “descendant”) is a special case of the other class (the “base class”). Those skilled in the art will appreciate that this is equivalent to an “inheritance” relationship in object-oriented software systems. Unless otherwise specified, an instance of a specialization of a given base class can be used in place of an instance of that base class.
Structured data object: A persistent or temporary memory structure of known class organized into at least one data field of known type.
Structured data: Data organized into discrete structured data objects of known type and data fields.
Succession relationship: A relationship between two fragment data objects that is not a containment relationship, wherein one fragment data object (the “predecessor”) appears before the other fragment data object (the “successor”) in the composite data message. Accordingly, the respective text fragment of the predecessor appears before the text fragment of the successor. In the drawings, succession relationships and succession relationship definitions are depicted using an arrow.
Text fragment: A portion of free-text, e.g., a paragraph or a sentence. According to one embodiment, a text fragment comprises one atomic unit of information for mapping to one structured data object.
Token: A single word or a number or a symbol or an unbroken sequence of symbols.
Unsatisfied relationship definition: A relationship definition applying to a composite data message, where that composite data message comprises insufficiently many relationships in accordance with that relationship definition.
Validation rule: A rule specifying the legal states for a structured data object or data field.
Verified: Refers the status of an entity, e.g., a class, a structured data object, or a data field, where the identity and data state of that entity has been manually confirmed as correct by a human user.
Workflow: A sequence of optional and/or mandatory transitions between stages applying to a composite data message. In one embodiment, a workflow also comprises none or more conditional branches and none or more conditional repetitions in the transition sequence.

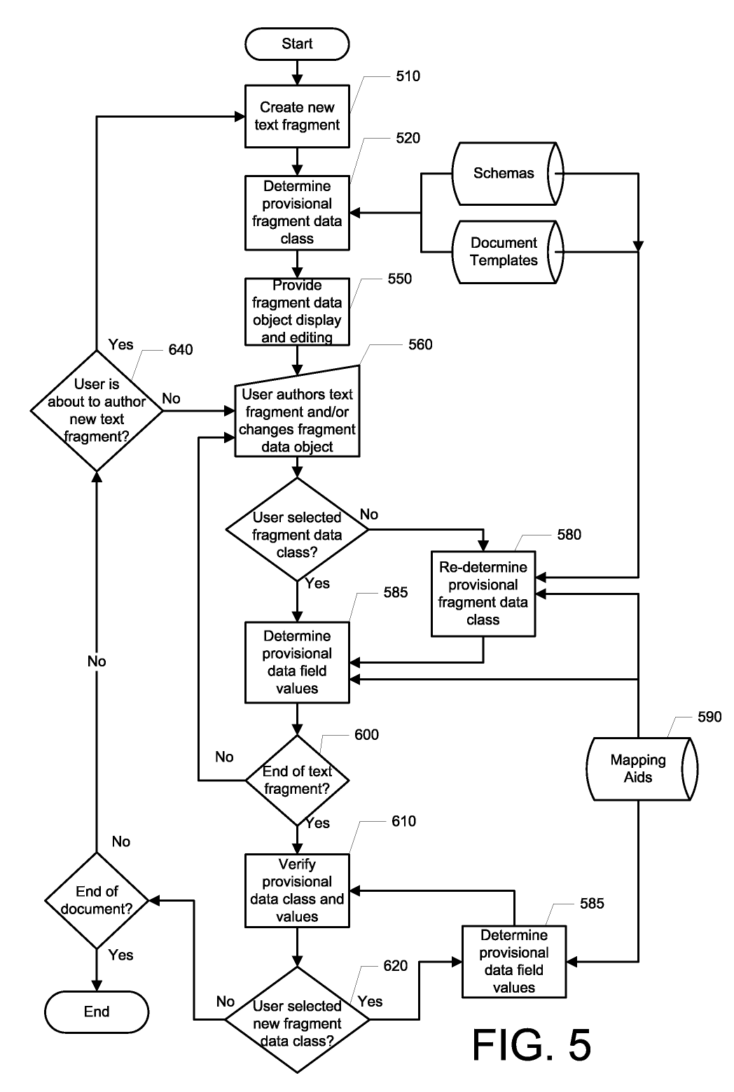

One embodiment is illustrated in FIG. 5, which shows a simplified flowchart for creating structured data corresponding to entered free text, and forming a composite message that includes the free text and the structured data. In one embodiment, a user is about to create a new text fragment in a composite data message. For example, each text fragment is one paragraph in length, and the user has pressed the Enter key on the keyboard thereby ending the current paragraph and indicating that a new text fragment is to be authored. The method includes in 510 creating a new text fragment, e.g., positioning the input cursor at the beginning of a new line.

In one embodiment, one or more schemas are in force, e.g., as a result of there being a message template selected by the user, or selected by default.

Furthermore, the method includes in 520 determining a provisional fragment data class for mapping the new text fragment, according to information supplied by the schema(s) in force for the composite data message, and the message template on which the composite data message is based. This is included in 103 of the exemplary flow chart of FIG. 1 as ascertaining whether one or more predefined text conditions are met.

In one embodiment, the step in 520 further includes creating a new fragment data object when the provisional fragment data class has been determined, the new fragment data object being an instance of the provisional fragment data class. This also is included in 103 of the exemplary flow chart of FIG. 1 as ascertaining whether one or more predefined text conditions are met.

The provisional fragment data class and the fragment data object are included in what is above called the proposed structured data.

The method includes in 550 providing a display and editing facility to the user for the provisional fragment data object. Note that this is included in 104 of the exemplary flow chart of FIG. 1. In one embodiment, in 550, the display facility for the active fragment data object includes displaying:
the name of the fragment data class of the active fragment data object;
the names of the data fields of the active fragment data object;
the values of the data fields of the active fragment data object; and
the relationships between fragment data objects.

Furthermore, in 550 the editing facility includes:
providing a mechanism of selecting a different fragment data class;
providing editing controls for each data field value, such that the type of editing control provided for a given data field is suitable for the data type of that data field; and
providing a mechanism for adding, editing or removing relationships between fragment data objects.

Furthermore, according to one embodiment of the present invention, the display and editing facility provided in 550 remains available to the user throughout the remainder of the authoring process.

In 560 the user proceeds to author the content of the active text fragment and/or to interact with the editing facility provided in step 550 to directly make changes to the active fragment data object. Such activity from the author is accepted by the method. This is included in 105 of the exemplary flow chart of FIG. 1 as accepting further input from the user indicative of the user modifying, approving, or rejecting the proposed structured data.

If, in 560, the user selects a different data fragment class, the active fragment data object is destroyed, and a new fragment data object is created based on the data fragment class selected by the user. A fragment data class selected manually by the user is considered verified, and is not subject to automatic change in step 580.

If, in 560, the user edits one or more data field values of the active fragment data object, these values are considered verified, and are not subject to automatic change in step 585.

If the fragment data class of the active fragment data object is still provisional, i.e., has not yet been verified by the user, the method includes in 580, re-determining the provisional fragment data class for mapping the active text fragment. The step in 580 uses the schema, the message template, and the mapping aids in 590. Specifically, the step in 580 uses class-level mapping aids that help to determine the fragment data class for the active text fragment based on the semantic content of the text fragment.

If in 580, determining the provisional fragment data class results in the selection of a new provisional fragment data class for the active fragment data object, the step in 580 includes automatically destroying the active fragment data object, and creating a new fragment data object of the newly determined fragment data class. The newly created provisional fragment data object is henceforth used as the active fragment data object.

Furthermore, the method includes in 585 determining provisional data field values for the active fragment data object, based on an evaluation of the semantic content of the active text fragment. Data fields with verified values are excluded from the automatic determination in 585. The step in 585 uses the mapping aids in 590. Specifically, the step in 585 uses field-level mapping aids that help to determine values for data fields based on the semantic content of the active text fragment.

The method includes in 600, determining if the user has finished authoring the active text fragment, for example the user has:
typed a delimiting token, for example, each text fragment is one paragraph in length and the user has pressed the Enter key;
closed the composite data message; or
used a keyboard, a mouse or other navigation mechanism to move the input focus off the active text fragment, thereby selecting another text fragment to be the active text fragment.

If in 600, the user has not indicated the end of the text fragment, the method continues at step 560.

Once the user has completed authoring the text fragment, the method includes in 610, verifying with the user the fragment data class and the value of each data field of the active provisional fragment data object.

If, in 610, the user manually changes the fragment data class of the provisional fragment data object, the method includes in 610 destroying the old provisional fragment data object and creating a new provisional fragment data object based on the fragment data class selected by the user. Furthermore, if the user has selected a new fragment data class in 610, the method includes in 585 determining the provisional data field values of the new provisional fragment data object.

Furthermore, according to one embodiment, the step in 610 further includes providing a mechanism for manually indicating that the active text fragment is not to be mapped. If, in 610, the user manually indicates that the active text fragment is not to be mapped, the method includes in 610 destroying the provisional fragment data object. According to an alternate embodiment, the step in 610 further includes providing a mechanism for manually indicating that none of the text fragments in a composite data message are to be mapped. If, in 610, the user manually indicates that the composite data message is not to have any text fragments mapped, the method includes in 610 destroying all provisional fragment data objects in the composite data message.

Thus, the input provided by the user as part of 560 through 610 is accepted (105 of FIG. 1).

According to one embodiment of the present invention, the method includes in 640 continuing at step 510 if the user is about to author a new text fragment. The method further includes in 640 continuing at step 560 if the user is about to continue authoring a pre-existing text fragment.

According to another embodiment of the present invention, if the user is not about to create a new text fragment, but rather has moved the input focus onto a pre-existing text fragment and is about to make modifications to this pre-existing text fragment, the method according to this embodiment commences at step 550, skipping steps 510 and 520. All other steps remain identical.

Furthermore, where the user is making modifications to a pre-existing text fragment, and the fragment data class of the corresponding active fragment data object has been previously verified, this status continues and the fragment data class of the active fragment data object is not subject to automatic change in steps 550 and 580. Also, where a data field value has been previously verified, this status continues and the value is not subject to automatic change in step 585.

When the user merges two text fragments, e.g., by removing a text fragment delimiter between the two text fragments, and both text fragments have associated fragment data objects there is a need to consolidate the fragment data objects into a single fragment data object. There are a number of methods for doing this. According to one embodiment, both fragment data objects are destroyed and the method resumes at step 580.

Mapping Constraints, Validation Behavior, and Mapping Candidates

According to one embodiment of the present invention, none or more mapping constraints can be defined by each of:
a fragment data class, wherein such mapping constraints apply to all instances of that fragment data class;
a relationship definition, wherein such mapping constraints apply to all relationships based on that relationship definition; and
an individual data field of a fragment data class, wherein such mapping constraints apply to that data field in all instances of that fragment data class.

Some examples of typical mapping constraints include:
requiring that the user be a member of at least one pre-determined security profile;
requiring that a user be one of a pre-determined group of authorized users;
requiring that the mapping must occur at one of a pre-determined set of specific stages in a pre-determined lifecycle that applies to the mapping target;
requiring that the mapping must occur at one of a pre-determined set of specific stages in a pre-determined workflow that applies to the composite data message; and
requiring the fragment data object to be in a relationship with another fragment data object, where that relationship is based on a particular relationship definition.

Referring to FIG. 5, the method includes in steps 520, 560, 580, and 610 selecting a fragment data class for use in mapping. According to one embodiment of the present invention, selecting a fragment data class is limited to selecting one of a set of candidate fragment data classes. In this embodiment, to be a candidate fragment data class, the fragment data class must:
be defined in a schema available to the active composite data message;
not violate any mapping constraint if selected in the current mapping decision; and
not violate any validation rule if selected in the current mapping decision.

The method includes in steps 560 and 585 assigning values to candidate data fields of the active fragment data object. According to one embodiment of the present invention, a data field is a mapping candidate only if:
the data field is a member of the active fragment data object;
assigning a value to that data field in the current mapping operation will not violate any mapping constraint; and
assigning the value specified for the assignment operation will not violate any validation rules associated with that data field.

The method includes in steps 520, 560, 580 and 610 creating relationships between fragment data objects. One embodiment of the present invention allows the creation of a relationship between fragment data objects only if:
the relationship will not violate any mapping constraint if created in the current mapping operation; and
the relationship will not violate any validation rules specified by fragment data class of either fragment data object.
   Satisfied and Unsatisfied Relationship Definitions

According to one embodiment of the present invention, a relationship between two fragment data objects is in accordance with a given relationship definition if it does not violate any mapping constraints imposed by that relationship definition and does not violate any validation rules applying to that relationship definition.

According to one embodiment, a relationship definition can impose none or more constraints including:
the fragment data class permissible for the first fragment data object of relationships in accordance with the relationship definition;
the fragment data class permissible for the second fragment data object of relationships in accordance with the relationship definition;
mapping constraints applying to relationships in accordance with the relationship definition;
the expected minimum number of relationships in accordance with the relationship definition, e.g., 1; and
the expected maximum number of relationships in accordance with the relationship definition, e.g., 1.

A relationship definition is unsatisfied if there exists fewer relationships in accordance with the relationship definition than is specified as the expected minimum number for that relationship definition.

A relationship definition is fully satisfied if there exists the same number of relationships in accordance with the relationship definition as is specified as the expected maximum number for that relationship definition.

According to one embodiment, a further mapping constraint applying to containment relationships is that no fragment data object can be a containee in more than one containment relationships, i.e., something contained in more than one containment relationships.

A given relationship is in accordance with a relationship definition if:
the first fragment data object of the relationship satisfies the fragment data class specified for the first fragment data object by the relationship definition;
the second fragment data object of the relationship satisfies the fragment data class specified for the second fragment data object by the relationship definition; and
the relationship does not violate any validation rules specified by the relationship definition.

A fragment data object satisfies a specified fragment data class if:
the fragment data object is of the same fragment data class; or
the fragment data object is of a specialization of the specified fragment data class.

A relationship satisfies a relationship definition if:
the relationship is in accordance with the relationship definition; and
the relationship definition is not already fully satisfied by one or more other relationships.

According to one embodiment, an automatically created relationship between two fragment data objects always satisfies exactly one relationship definition. Furthermore, a manually created relationship is not required to satisfy any relationship definition.

According to one embodiment, a relationship definition can optionally specify that it is a mandatory relationship definition, that is, the relationship definition must be fully satisfied in the composite data message. Furthermore, if a composite data message includes an unsatisfied mandatory relationship definition, and the user triggers an operation that includes saving or transmitting to one or more recipients the composite data message, then the method includes issuing an appropriate error message and canceling that operation.

According to another embodiment a relationship definition can optionally specify that it is mandatory in only one or more specific stages in a workflow, or in one or more specific stages in the life-cycles of its member's fragment data objects.

Mapping Decisions, Mapping Considerations, and Mapping Confidence Level

According to one embodiment of the present invention, automatic mapping decisions are made by evaluating the mapping confidence level associated with the possible outcomes for that decision and selecting the outcome with the highest mapping confidence.

Mapping decisions include:
Determining the provisional fragment data class for the active fragment data object;
Determining the provisional data field values for the active fragment data object; and
Determining the relationships between fragment data objects.

For determining the provisional fragment data class, the method includes evaluating at least one mapping consideration, including:
available unsatisfied containment relationship definitions;
available unsatisfied succession relationship definitions; and
available class-level mapping aids.

For determining the provisional data field values for the active fragment data object, the method includes evaluating additional mapping considerations, including available field-level mapping aids.

According to one embodiment, a mapping consideration includes:
A domain of mapping decisions to which the mapping consideration applies, e.g., the domain for one type of mapping considerations is for any mapping decision wherein a provisional fragment data class is selected;
a mechanism to determine if the mapping consideration is relevant to the current mapping decision;
a recommended outcome, i.e., the outcome that, if the mapping consideration is relevant, will maximize the mapping accuracy according to that mapping consideration; and
at least one indicator of confidence level for use in determining the mapping confidence level associated with the recommended outcome of the mapping consideration.

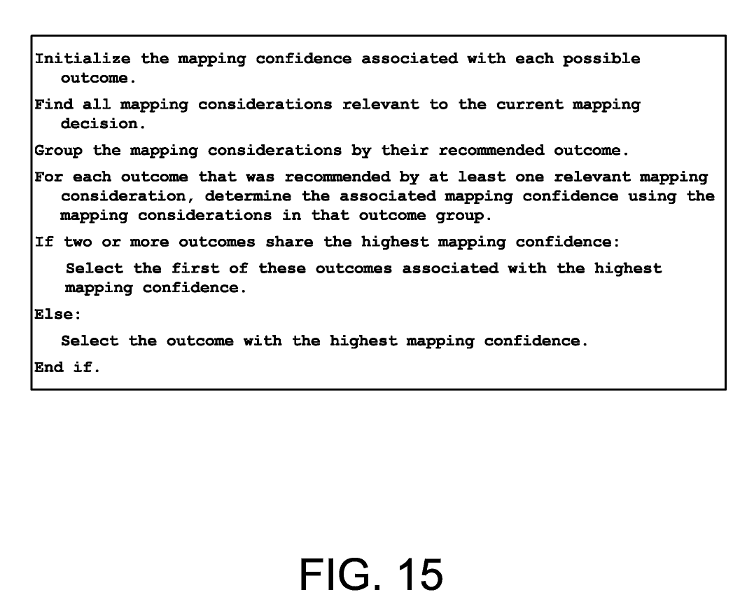

FIG. 15 shows pseudo-code that illustrates how in one embodiment, such a mapping decision is made based on evaluating at least one available mapping consideration.

According to one embodiment, the mapping confidence level for each outcome is initialized to a real-valued number, e.g., 0. According to one embodiment, the mapping confidence level for a given outcome is initialized to the relative frequency with which that outcome is verified as the correct outcome of a mapping decision.

According to one embodiment, each mapping consideration is assigned a single confidence level indicator, the confidence level indicator of a mapping consideration consisting of a pre-determined number indicative of the likelihood that mapping accuracy will be maximized in the event that:
that mapping consideration is relevant to the mapping decision; and
the mapping decision results in selecting the outcome recommended by that mapping consideration.

For example, such a confidence level indicator can be a real-valued number, n, such that 0≦n≦1.

Furthermore, according to one embodiment, determining the mapping confidence level associated with a given outcome includes computing a sum of the confidence level indicators of the group of mapping considerations recommending that outcome. The final mapping confidence level for a given outcome is determined by adding the initial mapping confidence level for that outcome to the sum of the mapping confidence levels of the relevant mapping considerations which recommend that same outcome.

Determining the Provisional Fragment Data Class

Referring to FIG. 5, according to one embodiment of the present invention, the method includes in 520 and 580 automatically determining a provisional fragment data class for the active text fragment.

According one embodiment, in 520, determining the provisional fragment data class for a new text occurs when the text fragment is still empty. Consequently, according to this embodiment, the method includes in 520 analyzing unsatisfied relationship definitions according to the respective fragment data classes of preceding fragment data objects to anticipate the likely semantic content of the new text fragment.

In 580, the active text fragment is no longer empty. Thus, in 580, determining the provisional fragment data class further includes parsing the existing tokens of the active text fragment, and, by using the mapping aids identifying the likely semantic content of that text fragment.

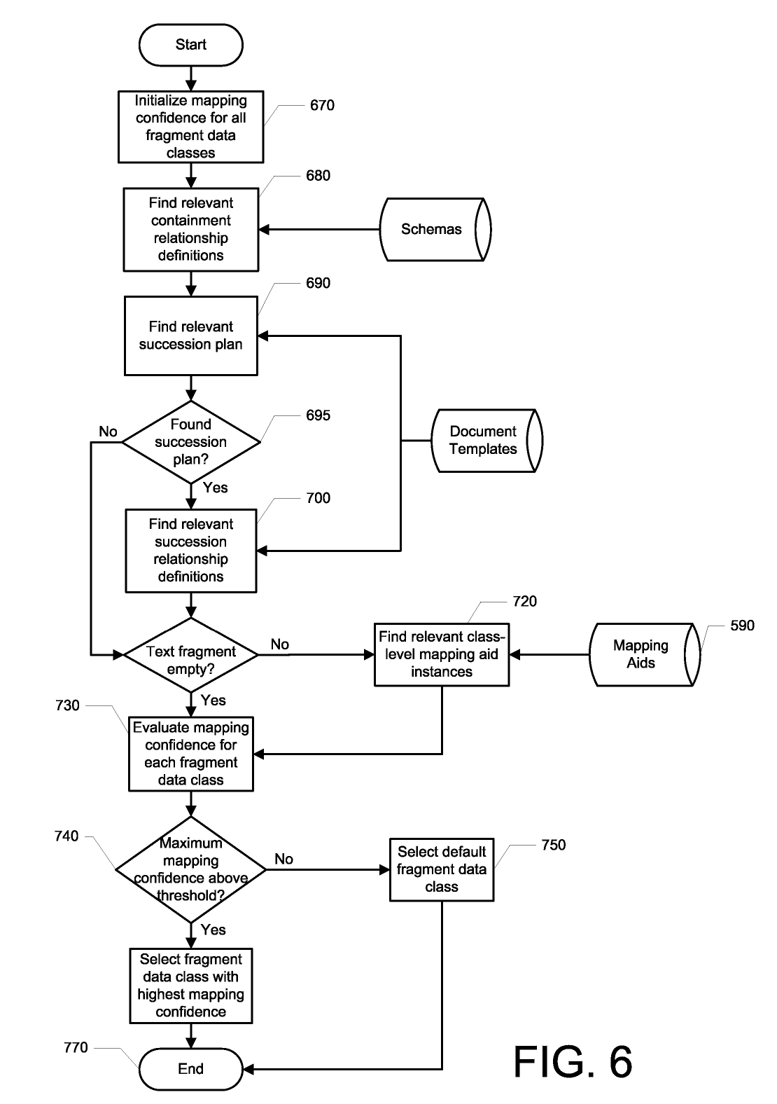

One method embodiment for determining the provisional fragment data class for the active fragment data object is illustrated in FIG. 6, which shows a simplified flowchart. The steps 520 and 580 of FIG. 5 both include the embodiment of FIG. 6. When the embodiment of FIG. 6 is invoked by the step 520 of FIG. 5 the active text fragment is empty, and consequently the step in 720 of FIG. 6 is not performed. When the embodiment of FIG. 6 is invoked by the step 580 of FIG. 5 the text fragment is not empty, and consequently the step in 720 of FIG. 6 is performed.

Here the method includes in 670 initializing the mapping confidence level for all fragment data classes. According to one embodiment, the mapping confidence level for all fragment data classes is set to 0.

In 680, the method includes finding the set of containment relationship definitions (if any) in the available schema(s) that are relevant to the current mapping operation. When a containment relationship definition is used as a mapping consideration, the recommended outcome of that mapping consideration is the fragment data class specified as the containee of that containment relationship definition.

In 690, the method includes finding the relevant succession plan (if any) in the message template on which the composite data message is based.

If, in 690, a relevant succession plan was found, then in 700, the method includes finding the set of relevant succession relationship definitions within the relevant succession plan. When a succession relationship definition is used as a mapping consideration, the recommended outcome of that mapping consideration is the fragment data class specified as the successor of that succession relationship definition.

If the active text fragment is not empty, then in 720 the method includes finding the set of class-level mapping aid instances relevant to the current mapping decision. In one embodiment, the relevance of a mapping aid instance is determined by parsing the contents of the active text fragment to detect the presence of a specified indicator, the indicator implying that the mapping aid instance is relevant. Each class-level mapping aid instance is associated with a fragment data class that is the recommended outcome of that mapping aid instance.

Furthermore, in 730, the method includes evaluating the mapping confidence level associated with each fragment data class that is a recommended outcome of at least one of:
the relevant containment relationship definitions;
the relevant succession relationship definitions; and
the relevant mapping aid instances.

The method includes in 740 checking that the maximum mapping confidence level assigned in step 730 is greater than a pre-determined mapping confidence level threshold. According to one embodiment, the mapping confidence level threshold is 0. According to another embodiment the step in 740 is not performed.

If the maximum mapping confidence level assigned in step 730 does not exceed the mapping confidence level threshold, the method includes in 750 selecting a pre-determined default fragment data class as the provisional fragment data class. Furthermore, according to one embodiment, if no such default fragment data class exists the method includes in 750 selecting the fragment data class most frequently used by the user. According to an alternate embodiment, if no pre-determined default fragment data class exists, then the last verified fragment data class used is re-selected.

If, in 730, exactly one fragment data class has been associated with the maximum assigned mapping confidence level, and that maximum mapping confidence level is in excess of the threshold, the method includes in 760 selecting that fragment data class.

If, in 730, more than one fragment data class has been associated with the same mapping confidence level, and that mapping confidence level is the maximum assigned, and is in excess of the threshold, then in 760 a tie-breaker is used.

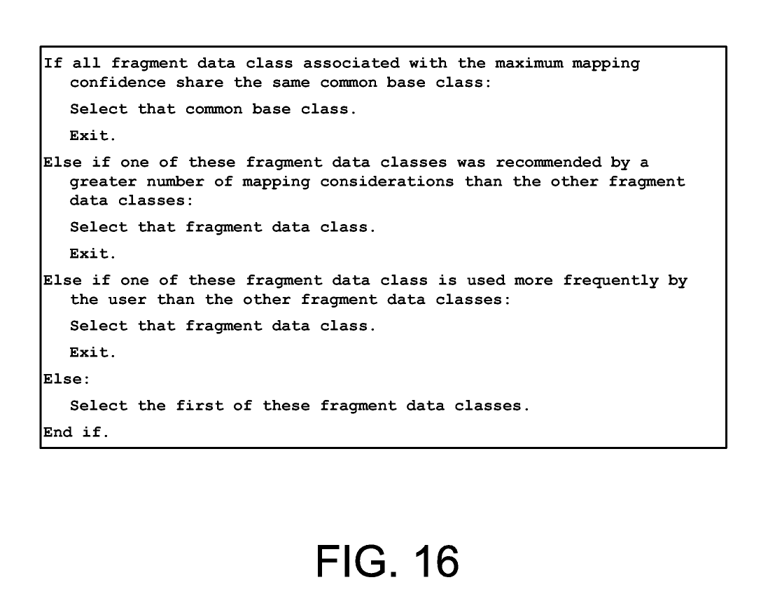

FIG. 16 shows pseudo-code that illustrates a tie-breaker used in one embodiment.

The selected fragment data class is used as the provisional fragment data class.

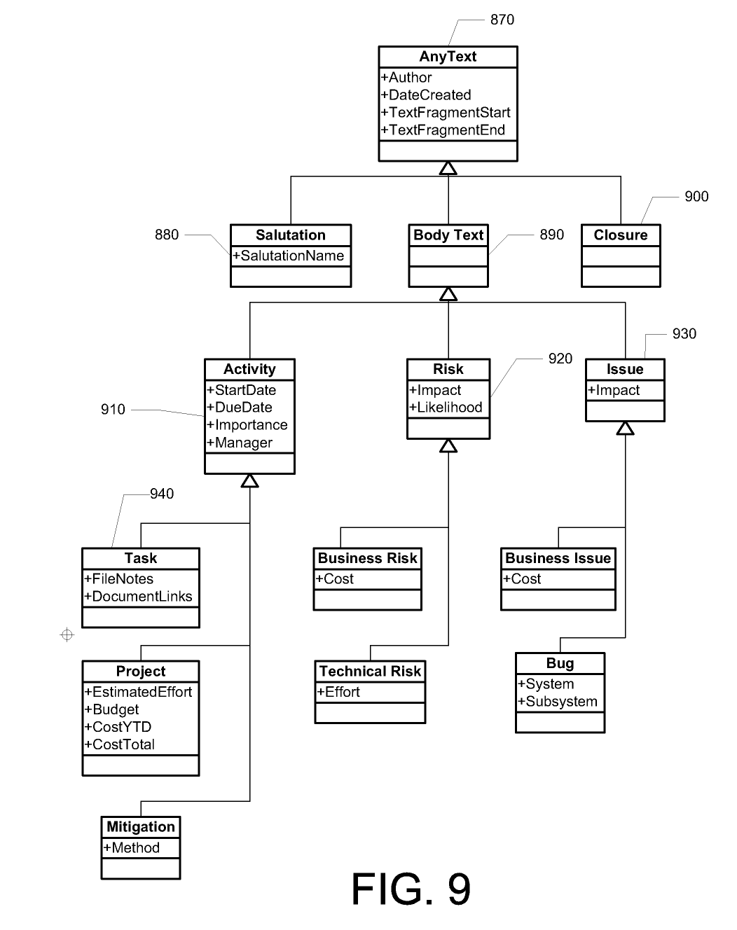

FIG. 9 shows an exemplary inheritance hierarchy for fragment data classes, such as could be used in a composite data message for use in activity management. According to FIG. 9 the AnyText 870 fragment data class is the most general base class, of which all other fragment data classes are specializations. The direct specializations of AnyText 870 include Salutation 880, BodyText 890, and Closure 900. The indirect specializations of AnyText 870 include Activity 910, Risk 920, and Issue 930. A fragment data object that is an instance of the Activity 910 fragment data class has data fields StartDate, DueDate, Importance, and Manager. A fragment data object that is an instance of Task 940 further comprises the data fields FileNotes and DocumentLinks.

Using Containment Relationship Definitions as Mapping Considerations

According to one embodiment of the present invention each available containment relationship definition can serve as a mapping consideration, such that:
the domain to which this mapping consideration applies is the determining of a provisional fragment data class; and
the recommended outcome of the mapping consideration is the fragment data class specified as the containee of the containment relationship definition.

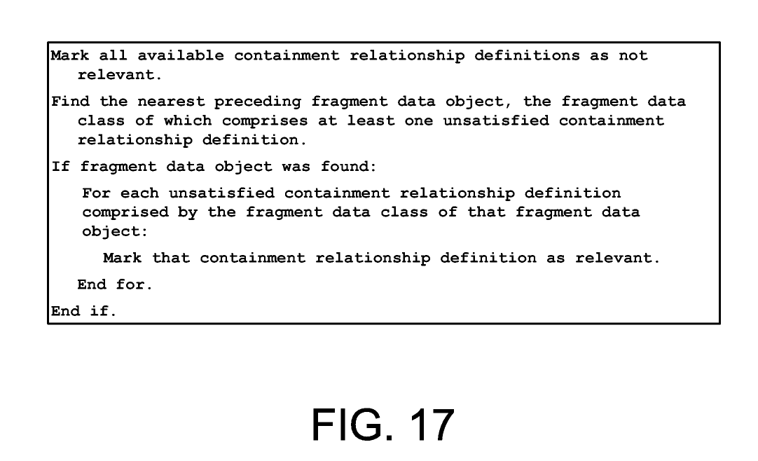

FIG. 17 shows pseudo-code that illustrates one method embodiment for determining if a containment relationship definition is a relevant mapping consideration in the current mapping operation.

According to one embodiment, at least one confidence level indicator is stored for each containment relationship definition.

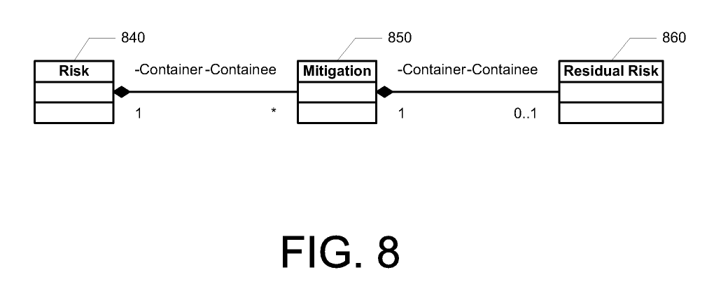

An exemplary containment relationship definition is illustrated in FIG. 8, which shows a simplified UML class diagram. According to this example, an instance of a Risk 840 fragment data class includes none or more containment relationships, wherein the Risk 840 instance is the container and the containees are instances of the Mitigation 850 fragment data class. Furthermore, each Mitigation 850 instance includes none or one containment relationship, wherein the containee is an instance of the Residual Risk 860 fragment data class.

Using Succession Relationship Definitions as Mapping Considerations

According to one embodiment, the message template can specify none or more likely succession plans, such that each plan specifies a pre-determined ordered series of fragment data class references. Any two adjacent fragment data class references in a succession plan constitute a succession relationship definition. Thus, a succession plan including more than one fragment data class reference also includes an ordered series of succession relationship definitions.

According to one embodiment, in a composite data message, any pair of fragment data objects form a succession relationship if:
both fragment data objects are containees of the same container; or
neither fragment data object is a containee of any container.

In such an adjacent pair forms a succession relationship, the first fragment data object is the predecessor, and the second fragment data object is the successor.

Where a message template defines more than one succession plan, unless otherwise specified by the message template, the first succession plan in the message template is the default succession plan.

According to one embodiment in FIG. 6, the step in 690 includes finding the relevant succession plan.

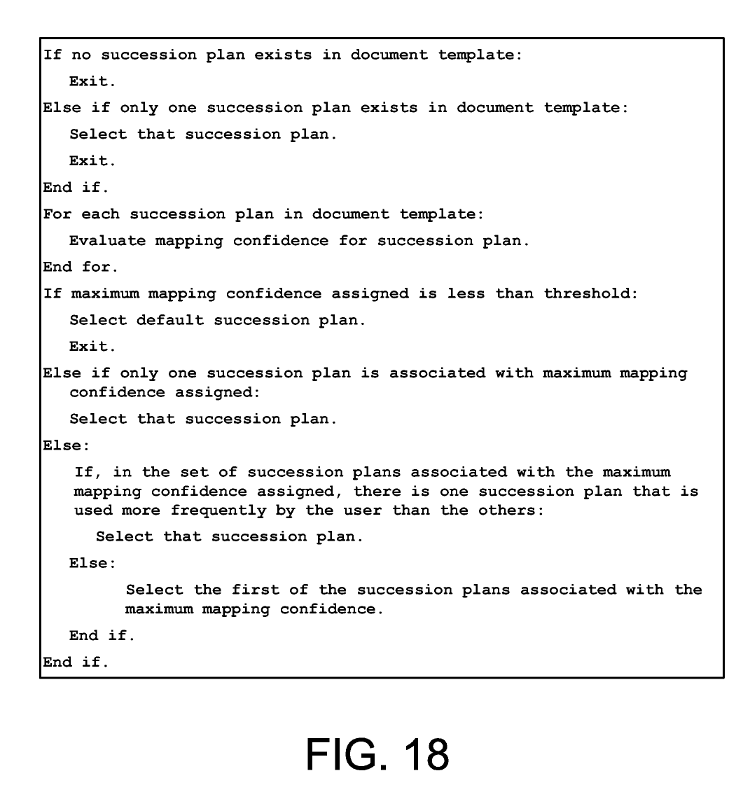

FIG. 18 shows pseudo-code that illustrates one method embodiment for finding the relevant succession plan.

According to one embodiment, the mapping confidence level of a given succession plan is given by the piecemeal function described by Table 1:

TABLE 1

| Condition | Value |
|---|---|
| The composite data message contains no | A pre-determined default |
| pair of adjacent fragment data objects | value associated with the |
| | succession plan. For |
| | example, the relative |
| | frequency with which |
| | this succession plan is |
| | used by the user. |
| The succession plan contains no | 0 |
| succession relationship definitions | |
| The composite data message contains N | j |
| pairs of adjacent fragment data objects, | N |
| of which j pairs each satisfy one | |
| succession relationship definition in the | |
| succession plan | |

According to one embodiment, at most one succession plan can be relevant to a mapping operation. Furthermore, a threshold is defined by the message template to specify the minimum mapping confidence level required for a succession plan to be considered relevant. According to one embodiment the threshold is a real valued number, m, such that 0≦m≦1, e.g., 0.

If such a succession plan is found to be relevant, the method in 700 includes finding the relevant succession relationship definitions within that relevant succession plan. Thus, each succession relationship definition available within the relevant succession plan can serve as a mapping consideration, such that:
The domain to which this mapping consideration applies is the determining of a provisional fragment data class; and
The recommended outcome of the mapping consideration is the fragment data class specified as the successor of the succession relationship definition.

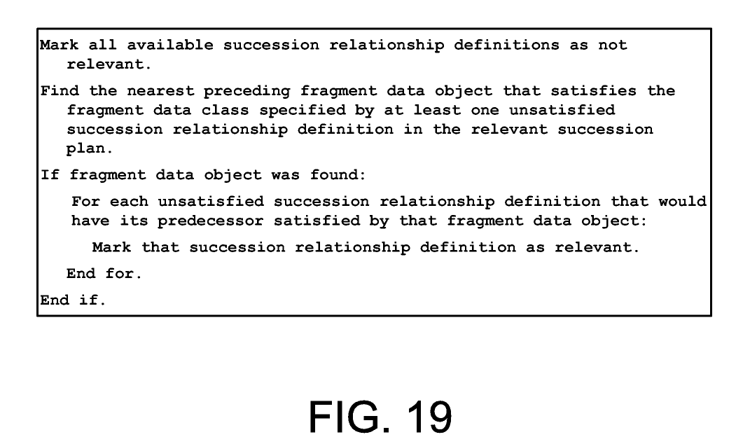

FIG. 19 shows pseudo-code that illustrates one method embodiment for determining if a succession relationship definition (in the relevant succession plan) is a relevant mapping consideration in the current mapping operation.

According to one embodiment, at least one confidence level indicator is stored for each succession relationship definition.

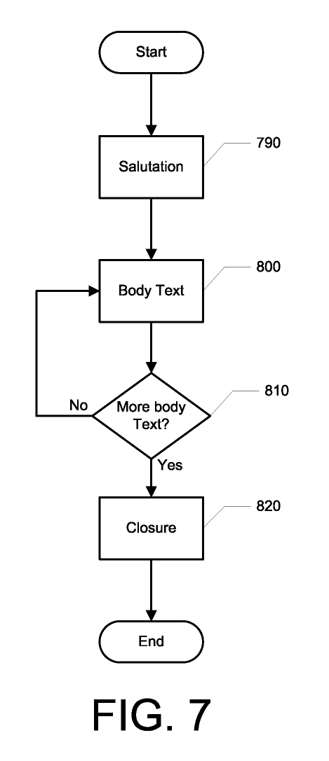

FIG. 7 shows a simplified flowchart of a succession plan for a message template that can be used for a typical composite data message. According to this succession sequence, a composite data message is likely to comprise the following sequence of fragment data classes:
The first fragment data object is an instance of the Salutation 790 fragment data class.
The Salutation 790 fragment data object is a predecessor in a succession relationship, the succession relationship having an instance of the Body Text 800 fragment data class as the successor.
The Body Text 800 instance is succeeded by none or more other Body Text 810 instances.
The final Body Text 800 instance is succeeded by an instance of the Closure 820 fragment data class.
   Using Class-Level Mapping Aids as Mapping Considerations

According to one embodiment of the present invention, the step in 720 (on FIG. 6), finds the set of all relevant class-level mapping aids to help determine a provisional fragment data class for the active text fragment.

According to one embodiment, each class-level mapping aid provides at least one mapping aid instance, where each instance serves as a mapping consideration, such that:
the domain to which the mapping consideration applies is the determining of a provisional fragment data class;
the relevance of the mapping consideration is evaluated by determining if a specific indicator is present in the text fragment; and
the recommended outcome of the mapping consideration is the fragment data class specified by that mapping aid instance.

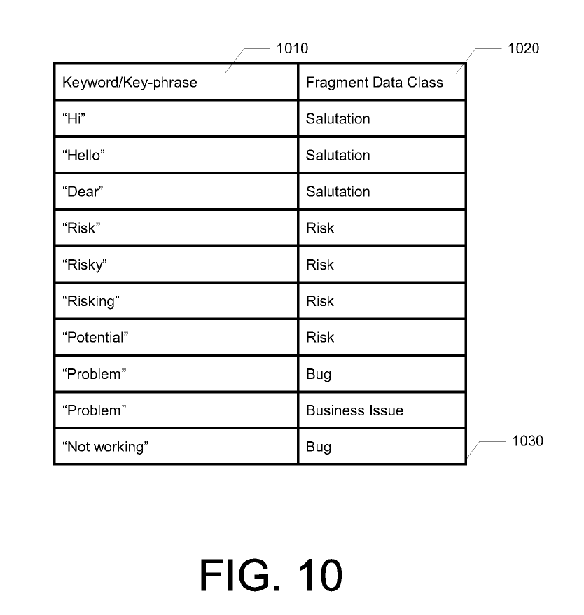

FIG. 10 shows an exemplary class-level mapping aid embodiment that is a lexical relation 1030. Here, the indicator is a keyword or a key-phrase 1010, and this indicator is being related to a fragment data class 1020 (the outcome recommended by that mapping aid instance). In this example, the presence of the keyword “Problem” within the active text fragment means that two mapping considerations are relevant and they respectively provide the following recommended outcomes:
the selected provisional fragment data class is “Bug.”
the selected provisional fragment data class is “Business Issue.”

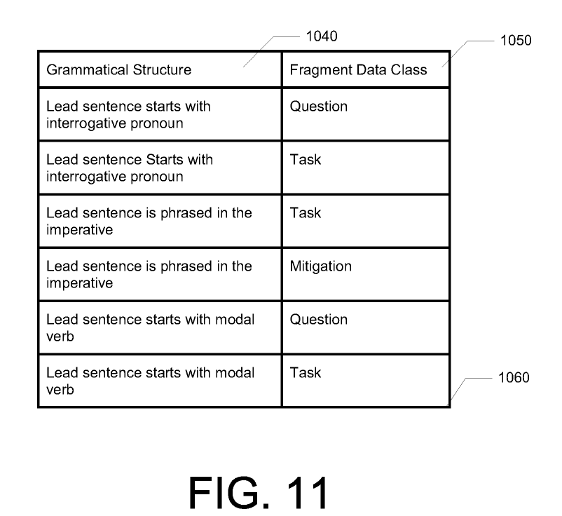

FIG. 11 shows another example of a class-level mapping aid. In this example a grammatical relation 1060 is used, wherein the indicator is the grammatical structure 1040 of the text fragment, and this indicator is being related to a fragment data class 1050. In this example, if the lead sentence of the active text fragment begins with an interrogative pronoun (e.g., “Where”) two mapping considerations are relevant, and they respectively provide the following recommended outcomes:
the selected provisional fragment data class is “Question.”
the selected provisional fragment data class is “Task.”

Those skilled in the art will appreciate that a number of lexical and grammatical parsers are known. Such prior art parsers can be used to locate the indicators of mapping aid instances in the active text fragment.

Using Field-Level Mapping Aids as Mapping Considerations

According to one embodiment of the present invention, the step in 585 (on FIG. 5), determines and assigns, where possible, provisional data field values to the respective data fields of the active fragment data object.

According to one embodiment, the step in 585 uses at least one field-level mapping aid. Each field-level mapping aid provides at least one mapping aid instance, where each instance serves as a mapping consideration, such that:
the domain to which the mapping consideration applies is the determining of a provisional value for a specific data field in a specific fragment data class to which the mapping consideration applies;
the mapping consideration is considered relevant if a specific indicator is present in the text fragment, and the corresponding fragment data object satisfies the fragment data class to which the mapping consideration applies; and
the recommended outcome of the mapping consideration is a value to be assigned to a specific data field included in the active fragment data object.

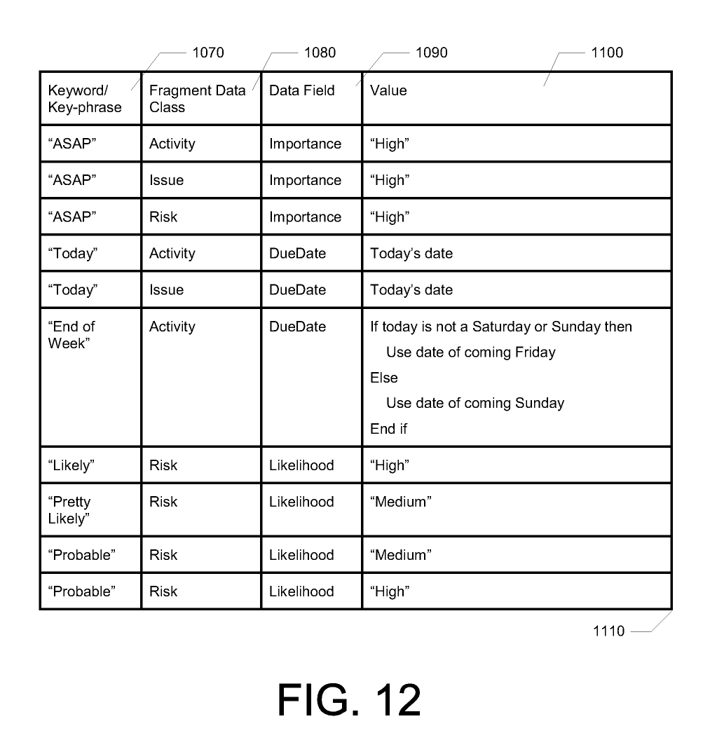

FIG. 12 shows an exemplary field-level mapping aid that is a relation 1110. Here the indicator is that the active fragment data object must be of a specific fragment data class 1080, and that a specific keyword or key-phrase 1070 must be present in the active text fragment for the mapping aid to be a relevant mapping consideration. Furthermore, the recommended outcome includes for each relation instance a tuple including the data field 1090 of the respective fragment data object to which a value is to be assigned, and the value 1100 to be assigned.

For example, the presence of the keyword “ASAP” in a text fragment currently mapped to a fragment data object of class “Activity” means that the recommended outcome is that the data field “Importance” be set to the value “High.”

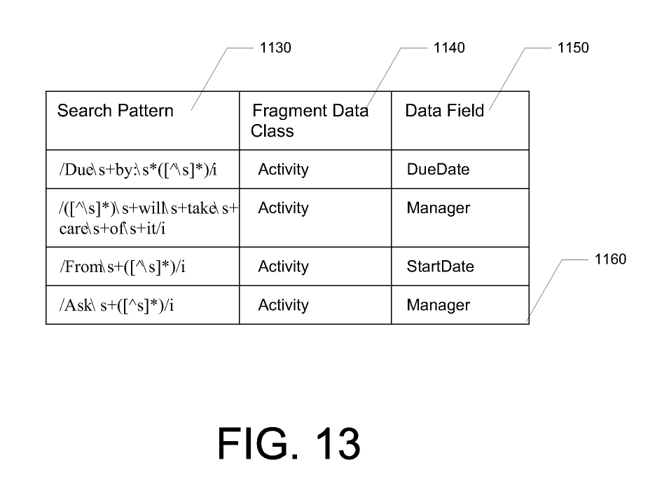

FIG. 13 shows another exemplary field-level mapping aid that is a relation 1160. Here the indicator is the presence of a given search pattern 1130 in a text fragment mapped to a fragment data object of a specific fragment data class 1140. The search pattern in this example is given as a regular expression. In this example, the recommended outcome is a tuple including the data field 1150 of the respective fragment data object to which the value is to be assigned, and the result of applying the search pattern 1130 to the text fragment.

For example, the presence of the token sequence “Due by:” in the text fragment means that the value following the word “by:” is to be assigned to the data field “DueDate.”

Determining the Confidence Level Indicator(s) for a Mapping Consideration

According to one embodiment of the present invention, each possible mapping consideration is assigned one pre-determined confidence level indicator, i.e., each relationship definition and each mapping aid instance is assigned one pre-determined confidence level indicator.

According to one embodiment, each of at least one mapping considerations is to be assigned a confidence level indicator. The plurality of mapping considerations is denoted herein as {MC₁, MC₂, MC_{3 . . .} MCₙ}, where n is the number of mapping considerations, with Cⱼ denoting the confidence level indicator for the j^{th} mapping consideration. The following piecemeal function determines a value for Cⱼ:

$$\begin{matrix}{k}_{j} < m & Set {C}_{j} = {D}_{j} \\ {k}_{j} \geq m & Set {C}_{j} = \frac{{v}_{j}}{{k}_{j}}\end{matrix}$$

where kⱼ is the total number of past text fragment mapping decisions where MCⱼ was relevant; m is a pre-determined threshold number of text fragments, e.g., 90; vⱼ is the number of times the recommended outcome of MCⱼ was the same as the final verified outcome of a past mapping decision; and Dⱼ is a pre-determined default confidence level indicator for MCⱼ, for example a factory default setting.

According to one embodiment, MCⱼ is stored in persistent and/or temporary memory and kⱼ, vj and Dj are stored as part of MCⱼ.

Creating Fragment Data Objects

According to the embodiment of FIG. 5 the method includes the creation of fragment data objects in 520, 560, 580 and 610.

According to one embodiment, creating a new fragment data object includes initializing any data field that has a pre-determined default value by assigning that default value to the data field of the new fragment data object.

According to one embodiment, if in 520, 560, 580, and 610 a new fragment data class is determined, and of the new fragment data class and the old fragment data class one is a specialization of the other, then the method includes:
creating a new provisional fragment data object based on the new fragment data class, initializing that new fragment data object;
copying all data field values from the old fragment data object to the corresponding data fields of the new fragment data object for all data fields common to both the old and the new fragment data class; and
destroying the old fragment data object.

Furthermore, if in 520 or in 580 a fragment data object is created based on a provisional fragment data class, where that provisional fragment data class was determined based on an unsatisfied containment relationship definition, the method further includes in 520 and 580 creating a containment relationship such that:
the preceding fragment data object, the fragment data class of which comprised that unsatisfied containment relationship, is the container of the new containment relationship;
the active fragment data object is the containee of the new containment relationship; and
the new containment relationship satisfies the previously unsatisfied containment relationship definition.

If in 520 or in 580 a fragment data object is created based on a provisional fragment data class, where that provisional fragment data class was determined based on an unsatisfied succession relationship definition, the method includes in 520 and 580 creating a succession relationship such that:
the preceding fragment data object, the fragment data class of which comprised that unsatisfied succession relationship, is the predecessor of the new succession relationship;
the active fragment data object is the successor of the new succession relationship; and
the new succession relationship satisfies the previously unsatisfied succession relationship definition.
   Destroying Fragment Data Objects

According to the embodiment of FIG. 5 the method includes the destruction of fragment data objects in 520, 560, 580 and 610.

Further according to this embodiment, when a fragment data object is destroyed the method includes:
destroying any relationship of which the fragment data object being destroyed was a member; and
considering as unsatisfied any relationship definition previously considered satisfied because of a relationship of which the fragment data object being destroyed was a member.
   Manually Changing the Fragment Data Class for the Current Mapping Operation

According to the embodiment of FIG. 5 the user can manually set the fragment data class for the current mapping operation in steps 560 and 610.

Furthermore, according to one embodiment of the present invention, if the user manually selects a fragment data class other than the previous provisional fragment data class, the method includes in 560 and 610:
destroying any relationships wherein the active fragment data object (based on the previous fragment data class) is a member;
destroying the active fragment data object;
creating a new active fragment data object based on the manually selected fragment data class; and
creating appropriate relationships for the new active fragment data object.

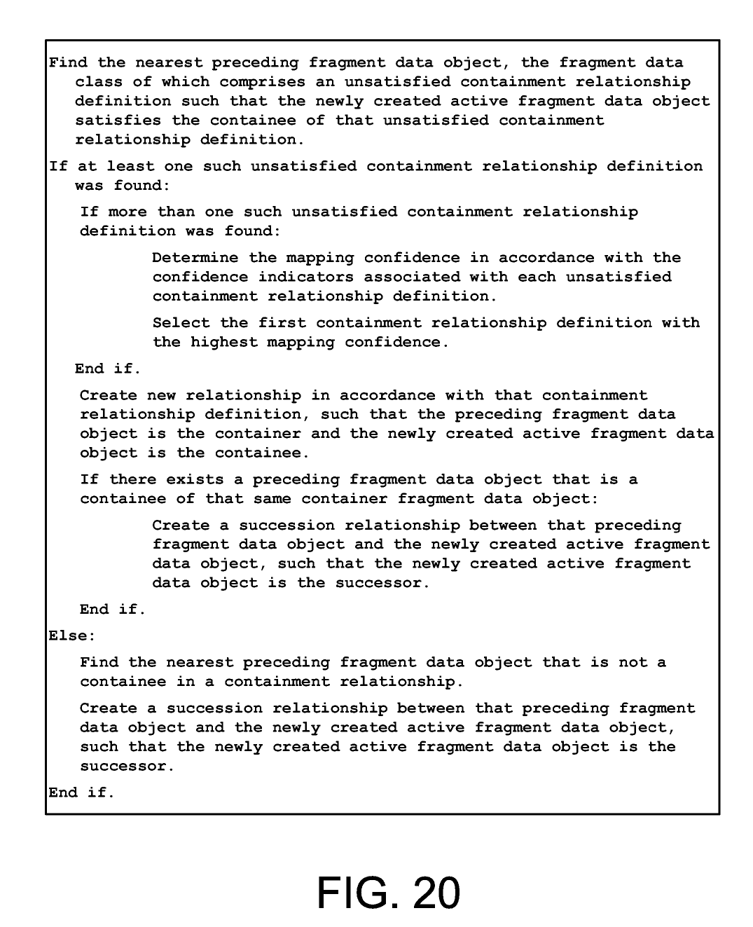

FIG. 20 shoes pseudo-code that illustrates one embodiment for creating appropriate relationships for the new fragment data object.

If the user manually selects a fragment data class other than the previous provisional fragment data class, such that one of the two fragment data classes is a specialization of the other, the method further includes in 560 and 610 copying the data field values of the fragment data object based on the previous fragment data class to the corresponding fields of the fragment data object based on the new fragment data class, for all data fields common to both classes.

The User Interface

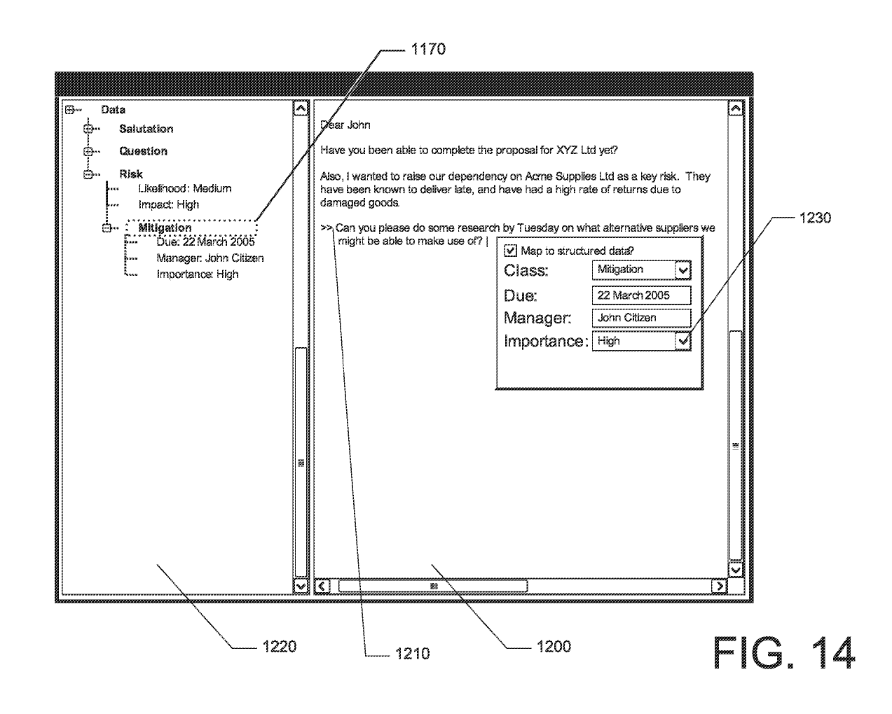

The user interface of one embodiment of the present invention is illustrated in FIG. 14. This exemplary user interface divides into two main sections:
the structured data section 1220; and
the free-text section 1200.

The structured data section 1220 displays (i.e. provides a visual model of) and makes editable the structured data contained in the composite data message.

The free-text section 1200 displays and makes editable the free-text contained in the composite data message.

In one embodiment, the structured data is represented in a tree (the “data tree”) in the structured data section 1220 containing a hierarchically arranged plurality of nodes, such that the root node of the data tree represents all data in the composite data message, and a given non-root node represents: a fragment data object; or the name and value of a data field of a fragment data object.

Each data field node in the data tree is represented as a child node of the node representing the fragment data object that includes that data field.

Those skilled in the art will appreciate that in such a hierarchically arranged tree a node that has sub-nodes is referred to as the “parent” node, while the sub-nodes are referred to as the “children” nodes. Nodes having the same parent are referred to as “siblings.”

In one embodiment, where a non-root node N₁ represents a data object O₁, and that node N₁ has a child node N₂ that represents a data object O₂, this represents a containment relationship, such that O₁ contains O₂.

Furthermore, where a node N₃ represents a data object O₃ and a node N₄ represents a data object O₄, and N₃ and N₄ are siblings and N₃ precedes N₄ in the data tree, this represents a succession relationship between O₃ and O₄, such that O₃ is the predecessor and O₄ is the successor.

According to one embodiment, the free-text section 1200 indicates a containment relationship between two text fragments by means of a containment indicator 1210 and by indenting the containee text fragment. The free-text section 1200 indicates a succession relationship by the relative positions of the corresponding text fragments, such that the text fragment of the predecessor data object appears before the text fragment of the successor data object.

Thus, reading the fully expanded tree in the structured data section 1220 from top to bottom creates the same reading order as when reading the text fragments in the free-text section 1200 from top to bottom. Where a text fragment has been excluded from mapping to a fragment data object by the user the data tree displays in the location corresponding to that text fragment a “non-mapped” node, such that the non-mapped node label indicates the special status of the corresponding text fragment to the user.

In one embodiment, exactly one text fragment and its corresponding data object are considered active (the “active pair”) at any one point in time. The active fragment data object is indicated to the user by means of a highlight 1170. The corresponding text fragment is indicated to the user by means of the input cursor in the free-text section 1200.

Thus, creating a new text fragment, the corresponding provisional fragment data object is displayed in the structured data section 1220. The position of the provisional fragment data object relative to other fragment data objects is determined according to the relative position and containment relationship(s) of the new text fragment to other text fragments.

Thus, in a newly created, empty message, the provisional fragment data object appears highlighted as the first non-root node of the data tree, while the input cursor is positioned at the beginning of the new, currently empty, first text fragment in the free-text section 1200.

In a composite data message including more than one mapped text fragment, the user can select another active pair using typical mechanisms for selecting on-screen elements within the free-text section 1200 and within the structured data section 1220, including: (a) by mouse-clicks; (b) by means of another indirect pointing device; (c) by arrow keys; and (b) by voice commands if a voice command interface is available.

According to one embodiment, when the user selects a new fragment data object in the structured data section 1220, thereby selecting a new active pair, the input cursor is positioned at the beginning of the corresponding text fragment in the free text section 1200.

The free-text section 1200 provides text editing facilities in accordance with typical word processing systems, e.g., Microsoft Word (TM) and Microsoft Notepad (TM).

In one embodiment, the structured data section 1220 provides editing facilities such that the user can manually set the class associated with a specific text fragment, e.g., by selecting from a pick-list. Similarly, the structured data section 1220 provides data controls for setting values for each data field such that the data control is appropriate for the data type of that data field, e.g.: edit boxes for text data fields; drop-down boxes for data fields with value lists; and drop-down calendar boxes for date fields.

Whenever the fragment data class for mapping a text fragment changes, e.g., when the user manually selects another fragment data class or an automatic process selects a new provisional data class, the data tree updates to reflect the name of the new fragment data class and the data fields of the newly created fragment data object.

Similarly, when the value of a data field changes the data tree updates to reflect the new value of the data field.

When the user finishes authoring a text fragment, a property page 1230 is displayed to verify the class and data field values of the data object for the text fragment. According to one embodiment, the property page 1230 is displayed adjacent to the end of the text fragment. The property page 1230 automatically receives the input focus.

According to one embodiment, the property page 1230 includes at least one of:
displaying the name of the fragment data class of the active fragment data object;
displaying the name and value of each data field of the active fragment data object;
providing for manually re-setting the fragment data class;
providing for manually re-setting the values of the data fields;
providing for manually accepting the mapping displayed on the property page 1230, including the manual changes the user has made; and
providing for manually canceling the mapping displayed on the property page 1230, including the manual changes the user has made.

In one embodiment, the active text fragment is highlighted when the property page is displayed, so as to indicate the full extent of the text fragment being mapped to the fragment data object shown in the property page.

The property page displays the names and values of the data fields of the active fragment data object. If the user manually resets the fragment data class, thereby triggering the creation of a new fragment data object for the text fragment, the property page 1230 is updated to reflect the data fields of the new data object.

According to one embodiment the mechanisms for accepting the manual changes the user has made on the property page 1230 include:
pressing an OK button; and
pressing the Enter key.

Furthermore, the mechanisms for canceling the manual changes the user has made on the property page 1230 include:
pressing a Cancel button; and
pressing the Esc (“Escape”) key.

In one embodiment, if the user accepts the mapping displayed on the property page 1230 this triggers:
closing the property page; and
completing the operation invoked by the user to end authoring the text fragment, e.g., starting a new text fragment.

Furthermore, if the user cancels the mapping displayed on the property page 1230, this triggers:
closing the property page;
preserving the original provisional and verified aspects of the active fragment data object prior to the display of the property page; and
canceling the operation invoked by the user to end authoring the text fragment, leaving the input focus on the most recently active text fragment.

According to one embodiment of the present invention, the structured data section 1220 provides for manually creating and removing relationships between fragment data objects. In one embodiment, using click-and-drag the user can move individual nodes of the data tree in the same manner as folders are moved in the well known Microsoft Windows Explorer (TM) interface. When a node representing a fragment data object is moved in this manner the pre-existing relationships are destroyed. The method further includes inferring the intended containment and succession relationships from the nodes new position in the data tree, and automatically creating new relationships according to these inferred relationships.

Furthermore, according to one embodiment when a node representing a fragment data object is manually moved in the data tree, the corresponding text fragment(s) in the free-text section 1200 are repositioned to match the data tree.

Message Templates

Embodiments of the present invention use message templates. Note that such use of message templates is different from in prior art systems where the user selects a template and is then displayed fields according to the template, so that the user can provide data for the fields. Such prior art use of templates is similar to prior art use of forms. In embodiments of the present invention, there is a default message template so that a user need not explicitly select a template, and furthermore, the filling in of the fields of the template is automatic and part of the authoring process, that is, part of the determining of the structured data based on analysis of free-text.

According to one embodiment of the present invention, a message template includes at least one of:
one or more schemas, either by reference or by inclusion;
none or more succession relationship definitions between individual fragment data classes;
none or more pre-defined text fragments and corresponding fragment data objects to be copied into the newly created composite data message;
none or more formatting specifications to be applied to the pre-defined text fragments in the newly created composite data message;
none or more free-text formatting styles that are to be available within the context of the newly created composite data message;
none or more references to and/or inclusions of pre-defined behaviors, e.g., macros, and at least one trigger for each of these behaviors; and
a reference to or inclusion of a workflow.

According to one embodiment, when creating a new composite data message a listing of available message templates is displayed to the user, that listing providing a mechanism for manually selecting a message template for the new composite data message. Furthermore, according to one embodiment, a pre-determined default message template is available and the user can create a new composite data message without explicitly selecting a message template. If the user elects to create a new composite data message without explicitly selecting a message template, then the new composite data message is based on the default message template.

According to one embodiment, basing a new composite data message on a message template includes:
making available the schema(s) and succession relationship definitions of the message template available to the composite data message;
copying any pre-defined text fragments and corresponding fragment data objects into the newly created composite data message in the order specified by the message template;
applying any formatting specifications specified for the pre-defined text fragments in the message template to the corresponding text fragments copied to the newly created composite data message;
making available any free-text formatting styles in the message template to the newly created composite data message;
making available any pre-defined behaviors of the message template to the newly created composite data message; and
executing any pre-defined behaviors that are specified to run on creation of a composite data message by the message template and by the authoring software system.

According to one embodiment, the message template is itself a message stored in a file of known format, e.g., an XML file according to a global XSD specification for message templates. The message template remains accessible to a composite message based on that message template by means of a location reference, e.g., a URL, to the template embedded within the composite data message.

According to one embodiment, each schema referred to in a message template is itself a message stored in a file of known format, e.g., XSD.

Furthermore, according to one embodiment, each schema includes the mapping aids for use with the classes defined in that schema.

Workflows and Lifecycles

According to one embodiment of the present invention, the status of a composite data message progresses according to a pre-determined sequence of optional and mandatory stages of a workflow defined by the message template on which the composite data message is based. The composite data message stores a reference to its current stage in the workflow.

The workflow defines at least one triggering condition for each stage of the workflow. When all triggering conditions for a given stage evaluate to true, the stage is considered reached, and the composite data message updates its workflow stage reference. For example, a given stage in a workflow has the following triggering conditions:
the current workflow stage of the composite data message is the directly preceding stage to the given stage; and
the message data message is being revised by a user with a specified security profile.

Furthermore, according to one embodiment of the present invention, the status of a fragment data object progresses according to a pre-determined sequence of optional and mandatory stages of a lifecycle defined by the fragment data class of the fragment data object. The fragment data object stores a reference to its current stage in the lifecycle.

The life-cycle defines at least one triggering condition for each stage of the life-cycle. When all triggering conditions evaluate to true, the stage is considered reached, and the fragment data object updates its lifecycle stage reference.

Representing Composite Data Messages in Memory

According to one embodiment of the present invention, a composite data message is represented in a temporary memory, e.g., RAM, and optionally in a persistent memory, e.g., on a hard disk. According to another embodiment, the composite data message is represented in data transmitted over a network.

According to one embodiment, each composite data message is for receiving by at least one recipient, where each such recipient is a human. According to another embodiment, some of the recipients are computer-implemented repositories, e.g., a database, and/or computer-implemented artificial agents.

Further, according to one embodiment, the composite data message is transmitted from the author to the recipient, e.g., as an email, such transmission via a network, e.g., a local area network (the “LAN”) or the Internet. The body of the email comprises an XML document organized into tag-delimited elements. For each such element the tags delimiting the element identify the name of the element and thus the meaning of the content of the element. In one embodiment, the XML document of the body includes:
(a) a top-level element for the XML document;
(b) an element that includes the free-text of the composite data message;
(c) a reference to the document template on which the composite data message is based;
(d) a reference to each schema in force for the composite data message;
(e) a element for workflow information, such that an attribute of the element identifies the workflow and the content of the element identifies the current stage of the composite data message in the workflow;
(f) a recursively nested element structure representing the structured data of the composite data message, that includes an ordered set of at least one element for representing a fragment data object, such that:
   (i) for each fragment data object there exists one element to represent that fragment data object, such that the name of the element identifies the fragment data class of the represented fragment data class;
   (ii) each element representing a fragment data object further comprises an attribute, such that the value of that attribute indicates the start of the text fragment corresponding to the represented fragment data object in the free-text of the message;
   (iii) each element representing a fragment data object further comprises an attribute, such that the value of that attribute indicates the end of the text fragment corresponding to the represented fragment data object in the free-text of the message;
   (iv) each element representing a fragment data object further comprises one element for each data field (the “sub-element”) of the represented fragment data object, such that the name of each sub-element identifies the name of the represented data field, an attribute of the sub-element identifies the data type of the represented data field, and the content of the sub-element indicates the value of the represented data field;
   (v) for each containment relationship in the composite data message, the element representing the container fragment data object of the relationship comprises the element representing the containee fragment data object of the relationship;
   (vi) for each succession relationship in the composite data message, element representing the predecessor fragment data object of the relationship precedes the element representing the successor fragment data object of the relationship;
   (iv) each element representing a fragment data object further comprises an element for lifecycle information (the “lifecycle element”), such that an attribute of the lifecycle element identifies the lifecycle applying to the represented fragment data object, and the content of the lifecycle element identifies the current stage of the fragment data object in that lifecycle;

According to one embodiment the above XML representation of the composite data message is also used for representing the composite data message in permanent memory.

According to one embodiment, during authoring the composite data message is represented in temporary memory, such that the temporary memory representation of a composite data message includes:
(a) a memory structure, e.g., a text buffer, for storing the free-text of the composite data message;
(b) a reference to the document template on which the composite data message is based;
(c) a reference to each schema in force for the composite data message;
(d) a reference to the workflow applying to the composite data message;
(e) a reference to the current stage in the applicable workflow of the composite data message;
(f) the memory structure of each fragment data object, comprising:
   (i) for each data field sufficient memory space for the data type of that data field, that memory space set to the value of that data field;
   (ii) a reference to the start of the corresponding text fragment in the free-text buffer;
   (iii) a reference to the end of the corresponding text fragment in the free-text buffer;
   (iv) a reference to the fragment data class of the fragment data object;
   (v) for each containee of the fragment data object a reference to that containee;
   (vi) for each container of the fragment data object a reference to that container;
   (vii) for each successor of the fragment data object a reference to that successor;
   (viii) for each predecessor of the fragment data object a reference to that predecessor;
   (ix) a reference to the current stage of the fragment data object in the lifecycle applying to the fragment data object.

Those skilled in the art will appreciate that well-known prior art methods exist, e.g., in C++, for linking memory objects such as the memory objects described above for storing fragment data objects in temporary memory to the class definition on which the memory object is based. Furthermore, such prior art techniques provide adequate methods for implementing behaviors for specific instances of a class, and for classes as a whole.

Alternate Embodiments

General Method: Alternate Embodiments

In the embodiment shown in FIG. 5, the steps of determining a provisional fragment data class 580 and determining provisional fragment data values 585 are performed as part of the process of manually authoring the text fragment. In some cases it is desirable to reduce computational overheads during the authoring process. Thus, according to one alternate embodiment, the steps 580 and 585 are deferred until after the user has indicated that the process of authoring the current text fragment has been completed, e.g., the user has typed a token that delimits text fragments.

Furthermore, in some cases the user prefers not to verify the fragment data objects at the conclusion of authoring each individual text fragment. Thus, according to another alternate embodiment, verifying a fragment data object in accordance with steps 610 is deferred, until the occurrence of a triggering event, for example the occurrence of:
the user manually triggers the verification process;
the user finishes authoring the composite data message; or
a pre-determined number of provisional fragment data objects require verification.

If verification is deferred and there are at least two provisional fragment data objects and the user manually changes the fragment data class of one of the provisional fragment data objects, the method includes:
destroying the old fragment data object;
creating a new fragment data object based on the manually selected fragment data class;
re-determining provisional data field values for the new fragment data object;
re-determining the provisional fragment data class of each fragment data object that is a containee of the active fragment data object; and
re-determining the provisional fragment data class and data field values for each fragment data object that is a successor of the newly created fragment data object.

There are many different ways of determining the extent of individual text fragments in the composite data message. Some examples include:
embodiments wherein each text fragment is one sentence in length;
embodiments wherein each text fragment is one paragraph in length;
embodiments wherein a text fragment is delimited using a user-definable special token or multi-token sequence;
embodiments wherein a text fragment is delimited using a user-definable special keystroke or key-stroke combination, where those key-strokes are not made visible tokens in the composite data message; and
embodiments where the user does not manually indicate the extent of each text fragment, but where the embodiment automatically determines the end of a text fragment, for example by determining that the end of a text fragment is reached when the corresponding mapping operation has successfully assigned values to all mandatory fields of the corresponding fragment data object.

Furthermore, an alternate embodiment includes determining if mapping the active text fragment is desirable in the first place. For example, a text fragment may be simply an exclamation, e.g., “Ouch!,” or one of a pre-determined set of standard platitudes, e.g., “How are you?”.

In some cases it is desirable to provide strong guidelines for authoring a specific type of composite data message. For example, in one case it is preferred that a particular type of composite data message follows a specific corporate standard. Thus, according to one alternate embodiment, the relevant provisional fragment data objects are forward-created when the composite data message is first created so that the user is immediately presented with the expected structure for that message. The forward-created fragment data objects are created in accordance with a forward creation plan included in the message template.

According to one alternate embodiment the forward-determined provisional fragment data objects are then re-determined as the user progresses to author and verify the composite data message.

According to yet another alternate embodiment, a fragment data object may relate to information available externally to the composite data message. In this embodiment, the step of determining provisional data field values in 585 includes using any identifying information that has already been captured in the fragment data object to look up the related information in the external software system, and where applicable, the step further includes the use of that information to determine the remaining provisional data field values.

For example, a fragment data object represents a customer record in an external customer relationship management (CRM) software system. Thus, when a customer fragment data object is created and the customer's ID number is assigned to the relevant data field, then the behavior defined for the customer fragment data class includes accessing the CRM software system, searching for the customer with the given ID, and automatically populating the name, contact details and order history data fields of that customer fragment data object. A plurality of additional fragment data objects may be created to accommodate this information.

Furthermore, according to another alternate embodiment of the present invention, the method includes writing standardized free-text based on a previously created and populated fragment data object. For example, in a composite data message that is to serve as a letter, the user has populated the customer fragment data object of the previous example, and now triggers the creation of a standardized address block at the top of the letter. In one embodiment, the method writes the customer's name and relevant contact details according to a standard layout and formatting specification for the address block of a letter.

In one embodiment, each fragment data class definition specifies none or more free-text generation behaviors, such that some behaviors apply to individual data fields, some apply to the class as a whole, and some apply to the class and the relationship definitions of that class. The user can selectively trigger such a free-text generation behavior. Furthermore, when triggering a free-text generation, the user can specify how the insertion of the newly generated free-text is to occur. For example, the user can specify:
that the newly generated free-text is to replace the text fragment corresponding to the fragment data object;
that the newly generated free-text is to immediately follow the text fragment corresponding to the fragment data object; and
that the newly generated free-text is to immediately precede the text fragment corresponding to the fragment data object.
   Relationships: Alternate Embodiments

According to an alternate embodiment, there exist other relationship types beside the containment and succession relationships discussed above. Examples of such other relationship types include:
dependency relationships, wherein the semantic content of one fragment data object is dependent on the semantic content of another, e.g., a chronological dependency between two activities, wherein the first activity must be completed before the second activity can commence;
extension relationships, wherein the semantic content of one fragment data object is an extension of the semantic content of another fragment data object, e.g., an extension relationship between a scheduled activity and a variation request that extends the original specification for the scheduled activity; and
replacement relationships, wherein the semantic content of one fragment data object replaces another, e.g., a scheduled activity that has been superseded by another activity.

According to one alternate embodiment such additional relationships are represented in the user interface using colored lines that connect the related fragment data objects, the color of a given relationship line indicative of the relationship type. Furthermore, one way for the user to manually create such relationships is by using click-and-drag techniques to move one fragment data object on top of the fragment data object with which it is to be related. If, because of the multiple possible relationship types, there is ambiguity as to which relationship type the new relationship is to have, a menu of the possible choices is presented to the user.

Furthermore, in some cases it is preferable to prohibit the creation of relationships that are not based on established relationship definitions. Thus, according to one alternate embodiment of the present invention a relationship cannot be created unless this relationship also satisfies a relationship definition. According to another alternate embodiment this type of restriction applies only to some of the possible relationship types. According to yet another alternate embodiment, this type of restriction applies only to some specific relationship definitions.

According to another alternate embodiment, inter-message relationships can be formed, wherein a fragment data object in one composite data message is a member of a relationship with another fragment data object in another composite data message. Preferably, an inter-message relationship is implemented such that each fragment data object has an appropriate reference to the other fragment data object, that reference including at least one of:
The location of the other composite data message.
The relevant access method for the other composite data message, that access method also including a mechanism for detecting if the relationship is no longer valid.
A reference to the fragment data object within the other composite data message.
A mechanism for manually destroying an inter-message relationship.

The reasons why an inter-message relationship becomes invalid include, for example, one (or more) of:
that one of the member fragment data objects is destroyed;
that one of the composite data messages is deleted;
that one of the composite data messages is made inaccessible to the user; and/or
that the relationship has been destroyed in the other composite data message.

If an access method determines that a relationship has become invalid because the relationship has been destroyed in the other composite data message, the method includes automatically destroying the relationship reference in the composite data message that invoked the access method.

According to yet another alternate embodiment, some relationship types may comprise three or more fragment data objects.

According to another embodiment, a fragment data class includes not only containment relationships but also none or more succession relationship definitions in which a fragment data object of that class is the predecessor. The message template does not contain any succession plans. In one embodiment, the steps 690 and 695 of FIG. 6 are not performed, and in step 700 the method further includes:
determining if the fragment data class of the fragment data object preceding the active fragment data object includes at least one unsatisfied succession relationship definition; and
if at least one such unsatisfied succession relationship definition exists, then using each unsatisfied succession relationship definition as a relevant mapping consideration.

Further, in one embodiment, relationships created automatically during a mapping operation are provisional and also require verification by the user. In one embodiment, verification further includes displaying the automatically created relationships and prompting the user to verify these relationships. When verifying a fragment data object, for each related fragment data object an excerpt of the respective text fragment and the relationship type is displayed on the property page for verification. The embodiment provides for the user to destroy a relationship and to approve the relationships.

Mapping: Alternate Embodiments

Referring to FIG. 5, in determining provisional fragment data classes in step 520 and 580, and determining provisional data field values in step 585, there are many alternate embodiments that enhance the mapping accuracy of individual mapping decisions in various situations.

According to one alternate embodiment, determining mapping confidence level associated with a specific outcome in a mapping decision includes, for example, taking into account at least one of:
how frequently that outcome has occurred in the past;
how frequently each relevant mapping consideration supporting that outcome has maximized mapping accuracy in the past; and/or
how frequently each relevant mapping consideration supporting that outcome has failed to maximize mapping accuracy in the past.

In one embodiment, for determining the mapping confidence level for a given outcome R in a given mapping operation, where n mapping considerations {MC₁, MC₂ . . . MCₙ} have been found relevant and recommend that outcome R, the confidence level indicators shown in the following Table 2 apply:

TABLE 2

| Confidence level | Notation |
|---|---|
| The probability that the recommended outcome, R, of the | P_{(R)} |
| mapping considerations is the correct outcome of the | |
| mapping decision | |
| The probability that the j^{th} mapping consideration, | P_{(j\R)} |
| MCⱼ, is relevant to a mapping | |
| decision given that the correct outcome of the mapping | |
| decision is also the recommended outcome, | |
| R, of that mapping consideration | |
| The probability that the j^{th} mapping consideration is relevant | P_{(j\˜R)} |
| to a mapping decision given that the correct outcome of the | |
| mapping decision is not the recommended outcome, R, of | |
| that mapping consideration | |

In one embodiment, the mapping confidence level that the correct outcome of the mapping decision is the outcome R is determined as follows:

Mapping confidence level=

$$\frac{( {P}_{( 1 \vert R )} \times {P}_{( 2 \vert R )} … \times {P}_{( n \vert R )} ) \times {P}_{( R )}}{( ( {P}_{( 1 \vert R )} \times {P}_{( 2 \vert R )} … \times {P}_{( n \vert R )} ) {P}_{( R )} ) + ( ( {P}_{( 1 \vert \sim R )} \times {P}_{( 2 \vert \sim R )} … \times {P}_{( n \vert \sim R )} ) \times {P}_{( \sim R )} )}$$

According to another embodiment, when determining a provisional fragment data class using relationship definitions as mapping considerations, there is an alternative to working with only the nearest preceding fragment data object, relative to the active fragment data object, having unsatisfied relationship definitions. In one embodiment, all unsatisfied relationship definitions for which the first fragment data class is satisfied by a preceding fragment data object are considered relevant. However, the embodiment moderates the confidence level indicators, so that the confidence level indicator of a given relevant relationship definition decreases proportionally with the number of fragment data objects between the active fragment data object and the preceding fragment data object.

According to another alternate embodiment, the selection of confidence level indicators used for each mapping consideration depends on the message template used. Each mapping consideration is designated a default set of confidence level indicators. A message template includes none or more confidence level indicator overrides, such that each override specifies:
a value;
the mapping consideration to which the override applies; and
the confidence level indicator to which the override applies.

In one embodiment, when a mapping decision is made, the step of determining the mapping confidence level for an outcome uses the values of the confidence level overrides of the message template on which the composite data message is based, instead of the default values associated with the relevant mapping considerations. The default values are used only if no override is available. This is useful where the outcomes of mapping decisions are likely to differ depending on the nature and purpose of the composite data message.

Similarly, other alternate embodiments further allow associating such confidence level indicator overrides with other aspects pertaining to the composite data message, such aspects including:
workflow stages, to override confidence level indicators for a specified workflow stage;
lifecycle stages, to override confidence level indicators for a specified lifecycle stage;
security profiles, to override confidence level indicators for users who are members of a specified security profile;
user identities, to override confidence level indicators for none or more specified users, e.g., where the specified user is the recipient of the composite data message; and
collaborative undertaking types, to override confidence level indicators for a specified type of collaborative undertaking, e.g., a software development project.

Furthermore, according to one embodiment there is a pre-determined precedence order for the use of mapping aids. In one embodiment, the result of a mapping aid used early on in the mapping decision is used to eliminate the subsequent evaluation of other mapping aid instances because they are no longer considered relevant, thus saving execution time. Another alternate embodiment stops evaluating mapping aid instances once an outcome has been discovered where the mapping confidence level associated with that outcome exceeds a pre-determined mapping confidence level threshold.

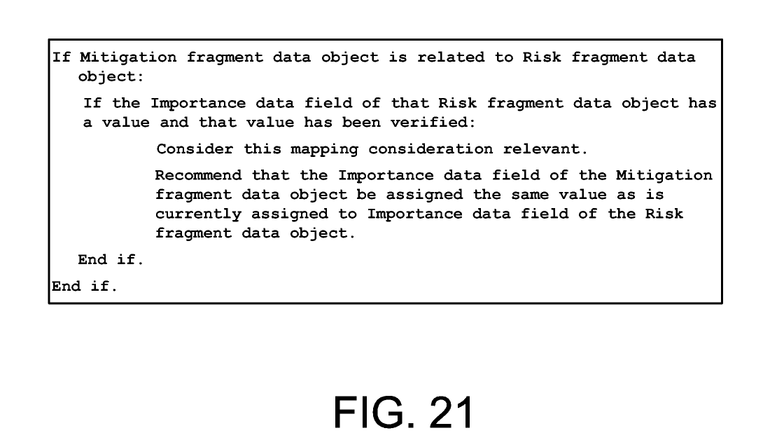

According to another embodiment, each instance of a given field-level mapping aid includes conditional logic for determining the relevance of a mapping aid instance and the recommended value for a specified data field for a fragment data object of a given fragment data class. For example, FIG. 21 shows pseudo-code for the conditional logic for a mapping aid applying to a fragment data object of the class “Mitigation.”

According to yet another mapping aid embodiment, the method includes:
determining if the composite data message is related to other composite data messages, e.g., it is a reply to a previous composite data message;
computing a higher mapping confidence level for fragment data classes that appear in the related composite data messages; and
computing an even higher mapping confidence level to fragment data classes which satisfy the containee of at least one unsatisfied relationship definition in the related composite data messages.
   Confidence Level Indicators

There are many methods for determining the initial values of the confidence level indicator(s) and confidence level indicator overrides associated with a mapping consideration, and also for refining those values over time. The discussion in this section applies to confidence level indicators and confidence level indicator overrides alike, and a reference to one should be taken as also a reference to the other.

For determining the initial value of a given confidence level indicator, alternate embodiments include:
using a factory default setting;
if the user is a member of a community of users, copying the community average for the equivalent confidence level indicator;
if the user is a member of an organization and that organization has a set of standard values for confidence level indicators, copying the standard value for that confidence level indicator; and
initializing the value based on an expected usage profile, e.g., a usage profile in accordance with the responsibilities of the user.

According to one alternate embodiment, if a confidence level indicator is a probability then that probability is determined by tracking the appropriate relative frequency for that confidence level indicator. For example, if the confidence level indicator is the probability that a given fragment data class is the correct outcome for a mapping decision, the relative frequency is determined by dividing the number of times that particular fragment data class was the correct outcome by the total number of mapping decisions resulting in a fragment data class being selected.

Furthermore, according to an alternate embodiment, the observed relative frequencies are measured not only for the individual user but also for the community of users to which a given user belongs. Thus, if a particular user has not authored a sufficient quantity of composite data messages to make the relative frequencies statistically representative, these values observed across that user's user community as a whole are used as overrides.

The User Interface: Alternate Embodiments

While FIG. 14 shows in simplified form one user interface embodiment for authoring structured electronic messages, there are many alternate embodiments to the user interface of FIG. 14.

When the hardware is in some way limited, in one version, the user interface is adjusted to the limited hardware. For example, suppose that one is operating on hardware with limited screen real-estate, e.g., a Personal Digital Assistant (PDA). According to one aspect of the invention, the user interface adjusts to not include the structured data section 1220, so that the information is applicable on the hardware with limited screen real-estate.

The data tree of the structured data section 1220 may be replaced by another mechanism for displaying fragment data objects and the relationships between them. For example, according to one embodiment, the structured data section 1220 instead includes a mind-map, wherein fragment data objects are depicted as nodes connected by “thought-lines” representing relationships. According to a simpler embodiment, a linear list of fragment data objects is used in place of the data tree, and relationships are depicted textually in another list that updates to show entries indicative of the relationships of the active fragment data object.

According to yet another alternate embodiment, the data tree further includes a mechanism, e.g., a pop-up menu, for re-including for mapping a node previously marked as “non-mapped.” When a non-mapped node is re-included for mapping the method includes:
determining the provisional fragment data class, creating a provisional fragment data object and assigning provisional data field values in accordance with steps 580 and 585 of FIG. 5; and
verifying the provisional fragment data object in accordance with steps 620 and 585 of FIG. 5.

Furthermore, according to one embodiment, the property page 1230 is displayed as a pop-up dialog. According to another embodiment, the property page 1230 is displayed in a fixed location as part of the main screen.

According to another embodiment, visual indicators for the extent of the active text fragment are continually displayed, e.g., a pair of colored carets, one adjacent to the start of the text fragment, the other adjacent to the end of the text fragment.

Furthermore, according to another alternate embodiment the present invention, significant token(s) are indicated, e.g., by underlining. Significant tokens include one or both of:
tokens that are used to determine that a mapping consideration is relevant, where the recommended outcome of that mapping consideration is the provisional fragment data class of the active fragment data object; and
tokens that are used to determine the value of a data field.

One embodiment provides for the user to activate a new text fragment/fragment data object pair without verifying the previous active pair and the verification step is deferred. In one embodiment, text fragments and/or fragment data objects that are not active and not verified are indicated, e.g., by highlighting.

Representing Composite Data Messages in Memory: Alternate Embodiments

According to one alternate embodiment, the composite data message is transmitted as part of an email, such that the free-text of the composite data message is included in the body of the email, and the structured data of the composite data message is a document that is an attachment to the email, e.g., an XML file.

According to another alternate embodiment, the method includes, embedding the message template on which the composite data message is based into the message, such that the message comprises the information of the template.

According to yet another alternate embodiment, the method includes, embedding the schema(s) available to the composite data message into the message itself, such that the message comprises the information of each available schema.

Furthermore, according to one embodiment, the memory representation of a fragment data object, e.g., an XML element in an XML document, comprises not only the structured data of the fragment data object, but also the free-text of the text fragment corresponding to the fragment data object. In one embodiment, the free-text of the composite data message is stored within the fragment data objects.

According to an alternate embodiment, a relational database is used to make composite data messages persistent. Those skilled in the art will appreciate that techniques are known for representing such information in a relational database system.

Similarly, according to another alternate embodiment, a relational database system is used to store any of:
the message template; or
the schemas (including associated mapping aids).

Those skilled in the art will appreciate that there are many ways of storing the information associated with the present invention in persistent memory, including proprietary binary format files, object-relational, and object-oriented databases.

Furthermore, in some types of hardware, e.g., some Personal Digital Assistants (PDAs), there exists no temporary memory, and the current program state is typically written immediately into a persistent memory. Consequently, embodiments performable on such hardware do not require a separate set of memory structures for representing composite data messages, message templates and schemas in temporary memory.

Those skilled in the art will appreciate that many more embodiments are possible for representing a composite data message within temporary memory, permanent memory and as part of a data for transmitting to at least one recipient over a computer network.

Other Aspects: Alternate Embodiments

According to one alternate embodiment, the step of verifying the provisional fragment data class and data field values in 610 on FIG. 5 is simplified to only provide the user with mechanisms to approve and reject the provisional fragment data object, e.g., a dialog box entitled “Verify” with an OK and a Cancel button. If the user rejects the provisional fragment data object, e.g., by pressing the Cancel button, the dialog box is closed, the operation that invoked the verification is aborted and the user is returned to the authoring environment as per step 560. If the user verifies the provisional fragment data object, e.g., by pressing the OK button, the fragment data object is considered verified and the operation that invoked the verification step is completed.

Those skilled in the art will appreciate that performance gains can be achieved by various prior art methods. For example the creation and destruction of temporary and permanent memory structures for storing fragment data objects is performed in bulk. According to one embodiment, instead of creating one fragment data object memory structure at a time, a plurality of fragment data object memory structures is created and initialized at once. The memory structures are then used as and when required, without requiring additional time in allocating memory and initializing data fields at time of use. Similarly, according to another embodiment, destroying a fragment data object includes marking the memory structure as no longer required, but the actual release of that memory and any task to reduce internal memory fragmentation is deferred. Such deferred activities can be carried out periodically, and during periods of reduced system use.

Those skilled in the art will appreciate that many speed improvements can also be achieved by forward calculating frequently used intermediate results and caching them in high-speed memory, e.g., pre-calculating intermediate results ahead of the time needed and caching the intermediate results. For example, according to one embodiment, confidence level indicators for individual mapping considerations are determined by computing a number of source values, e.g., probabilities. Once a confidence level indicator has been calculated, in one version, the confidence level indicator remains cached in the computer's memory. In one embodiment, the confidence level indicator value is re-determined at regular relatively infrequent intervals, e.g., daily. According to another embodiment, cached confidence level indicators are re-determined only when a pre-determined number of composite data messages have been authored.

Features of Using an Embodiment

The method for authoring composite data messages of this invention can be used to capture structured data representative of the semantic contents of a corresponding body of free-text. Furthermore, the invention allows a wide variety of embodiments that can be tailored to maximize mapping accuracy for an individual user and a community of users.

For example, according to one embodiment, an automated experiential learning method trains on corpora of verified mappings in past composite data message to improve mapping accuracy for similar future messages, e.g., composite data message authored by the same user, and composite data messages authored within the same group of users. Those skilled in the art will appreciate that many such experiential learning methods exist in the art, including neural networks.

Further, other embodiments use prior art methods exist for natural language processing to enhance the accuracy of mappings, and in particular to improve the accuracy of mapping aids that depend on a grammatical analysis of the free-text.

According to yet another embodiment, a mapping decision uses as one type of mapping aid prior art methods for determining how relevant a specific keyword within a free-text document is to the semantic content of that free-text. For example, the embodiment generates a higher mapping confidence level for the recommended outcome of a mapping aid instance if the indicator of that mapping aid instance is repeated multiple times in the text fragment, and if the indicator appears in a prominent position in the text fragment.

Those skilled in the art will appreciate that many more embodiments exist that use a combination of known techniques to improve accuracy of free-text to structured data conversion decisions.

In addition, in other alternate embodiments, information contained in external software systems, e.g., workflow software systems and activity management software systems, is used to maximize mapping accuracy. For example, given a project plan, one alternate embodiment determines the current activities for the current user according to the project plan, and uses this knowledge to automatically assign provisional due date values to fragment data objects representing related activities included in the active composite data message.

Similarly, functionality contained in external software systems, e.g., plug-ins, can be used to parse free-text fragments and return information for use as mapping aids.

Other embodiments of the present invention place less importance on maximizing mapping accuracy, and instead automatically create a none or more fragment data objects and relationships when a new composite data message is first created and the user is encouraged or required to author the free-text in accordance with the succession and data field requirements of these automatically created components. Typically such automatically created fragment data objects and relationships are in accordance with a specification included in the message template on which the composite data message is based.

Embodiments vary with respect to the architecture of fragment data classes and relationships. For example, according to one embodiment there is no specialization mechanism for fragment data classes.

Furthermore, embodiments may vary with respect to their user interfaces, as well as with respect to the terminology used to communicate with the user. Some embodiments provide alternate user interfaces tailored to specific hardware limitations, e.g., small screen real estate. Other embodiments provide alternate user interfaces to take advantage of specific available hardware and software features, e.g., voice recognition software systems for authoring free-text. Some embodiments vary with respect to the relative positioning of displayed components.

The user interface component used to represent the structured data will vary depending on the type of information the embodiment is designed to model.

Further, as will be appreciated by those skilled in the art, embodiments exist wherein the messages authored in accordance with the invention are not immediately sent to one or more recipients. For example, the composite data message is held as a document file for an optional later transmission to at least one recipient.

According to yet another embodiment, the author is one of the at least one recipients of the composite data message.

While in the embodiments described above, the user provides the free-text fragments of the message, and is presented with the provisional structured data, in other embodiments the free-text of the message may be provided by a different user, e.g., in the form of a received message. The method then proceeds as described herein to convert the free-text fragments of the message into structured data, including presenting the provisional structured data to the user. In such other embodiments, the user is not necessarily the original creator of free-text fragments.

Those skilled in the art will appreciate that the name of a software system-internal component can differ to the name displayed to a human user to denote that same component (the “external name”). Thus, according to one embodiment, both classes and their respective data fields have an internal name and an external name, where only the external name is used for display to a human user.

Note that terminology commonly used in “object-oriented” design is used in the description of some embodiments. Furthermore, object-oriented programming methods are used to implement some embodiments or aspects thereof. The invention however is not limited to object-oriented methods, and may be embodied using non-object-oriented methods. Those in the art reading the description herein will understand how to implement the elements described herein using alternates to object-oriented methods.

Furthermore, the present invention may be implemented using any combination of computer programming software, firmware or hardware.

Those skilled in the art will appreciate that embodiments exist for a wide variety of composite data message formats, including formats for transmission by email, instant messages, and SMS.

Throughout this description, the embodiments and examples shown should be considered as exemplary, rather than as limitations of the present invention.

For example, while English was the free-text language used in the examples, the invention is applicable to text messages in any written language.

Note that the methods described herein may be coded into software.

Unless specifically stated otherwise, as apparent from the following discussions, it is appreciated that throughout the specification discussions utilizing terms such as “processing,” “computing,” “calculating,” “determining” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data from registers and/or memory to transform that electronic data into other electronic data that may be stored in registers and/or memory. A “computer” or a “computing machine” or a “computing platform” may include one or more processors.

The methodologies described herein are, in one embodiment, performable by a machine, which includes a one or more processors that accept computer-readable instructions. For any of the methods described herein, when the instructions are executed by the machine, the machine performs the method. Any machine capable of executing a set of instructions (sequential or otherwise) that specify actions to be taken by that machine are included. Thus, one a typical machine may be exemplified by a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein also encompasses a storage system such as a disk drive unit. The processing system in some configurations may include a sounds output device, and a network interface device. The memory subsystem thus includes a carrier medium that carries machine readable instructions (e.g., software, a program) including instructions for performing, when executed by the processing system, one of more of the methods described herein. The software may reside in the hard disk, or may also reside, completely or at least partially, within the RAM and/or within the processor during execution thereof by the computer system. Thus, the memory and the processor also constitute carrier medium carrying machine readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while some diagram(s) only show(s) a single processor and a single memory that carries the code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer program that executes on a processing system. Thus, as will be appreciated by those skilled in the art, embodiments of the present invention may be embodied as a method, an apparatus such as a special purpose apparatus, an apparatus such as a data processing system, or a carrier medium, e.g., a computer program product. The carrier medium carries one or more computer readable instructions that when executed by one or more processors of a processing system, cause the processing system to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program instructions embodied in the medium.

The software may further be transmitted or received over a network via the network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by the machine and that cause the machine to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to include, but not be limited to, solid-state memories, optical and magnetic media, and carrier wave signals.

It will be understood that the steps of methods discussed are performed in one embodiment by an appropriate processor (or processors) of a processing (i.e., computer) system executing instructions stored in storage. It will also be understood that the invention is not limited to any particular implementation or programming technique and that the invention may be implemented using any appropriate techniques for implementing the functionality described herein. The invention is not limited to any particular programming language or operating system.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly, it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

All publications, patents, and patent applications cited herein are hereby incorporated by reference.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

Similarly, it is to be noticed that the term coupled, when used in the claims, should not be interpreted as being limitative to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

What is claimed is:

1. A method for providing structured data from a free-text message for sending to one or more recipients, the method comprising:
(a) accepting input indicative of a text fragment of the message;
(b) analyzing the accepted input to ascertain whether one or more predefined text conditions are met;
(c) in the case it is ascertained that one or more of the predefined conditions are met, providing to a user output indicative of proposed structured data corresponding to the accepted input;
(d) accepting from the user additional input indicative of selective modification and/or approval of the proposed structured data; and
(e) repeating steps (a) to (d) until all data indicative of all text fragments included in the message are accepted and analyzed,
such that in the case all data indicative of all text fragments included in the message are accepted, analyzed, and the structured data thereof modified and approved, one or both of the approved structured data and the message are sendable to one or more recipients.

2. A method as recited in claim 1, further comprising:
(f) in the case all data indicative of all text fragments included in the message are accepted, analyzed, and the structured data thereof modified and approved, sending one or both of the approved structured data and the message to one or more recipients.

3. A method as recited in claim 2, wherein the sending in (f) is in response to an explicit command to send being provided by the user.

4. A method as recited in claim 2, wherein the sending in (f) is in response to an explicit command that all text and structured data is approved.

5. A method as recited in claim 1, wherein the message is created by the user.

6. A method as recited in claim 1, wherein the message is created by another user different from the user.

7. A method as recited in claim 1, wherein the text fragment is provided as free text.

8. A method as recited in claim 7, wherein the analyzing of (b) includes one or both of analyzing the accepted input corresponding to the text fragment, and analyzing the relationship of the text fragment to one or more previously accepted inputs corresponding to text fragments.

9. A method as recited in claim 7, wherein the analyzing of (b) includes one or both of analyzing the accepted input corresponding to the text fragment, and analyzing the approved structured data corresponding to one or more previously accepted inputs corresponding to text fragments.

10. A method as recited in claim 7, wherein the free text is provided during authoring of an electronic message.

11. A method as recited in claim 1, wherein one or more predefined text conditions is associated with one or more structured data types, and the proposed structured data includes one or more of the structured data types associated with the met text conditions.

12. A method as recited in claim 11, including the step of providing a framework for the association of text conditions to structured data types.

13. A method as recited in claim 11, wherein the method is implemented in an environment and the association of text conditions to structured data types is environment specific.

14. A method as recited in claim 11 including the step of identifying one or more structured data types associated with the met text conditions.

15. A method as recited in claim 14, including the step of analyzing the one or more identified structured data types for identifying a preferred selection of structured data types.

16. A method as recited in claim 15, wherein the preferred selection of structured data types includes one or more or all of the identified structured data types.

17. A method as recited in claim 15, wherein analyzing the one or more identified structured data types includes applying a mapping protocol.

18. A method as recited in claim 17, wherein the mapping protocol includes a confidence level assessment.

19. A method as recited in claim 17, wherein the mapping protocol includes assessment of previously approved structured data.

20. A method as recited in claim 17, wherein the mapping protocol includes analysis of one or more attributes associated with the user.

21. A method as recited in claim 17, wherein the mapping protocol includes analysis of one or more attributes associated with one or more of the recipients.

22. A method as recited in claim 17, wherein the mapping protocol includes analysis of one or more relationship attributes relating to the user and one or more of the recipients.

23. A method as recited in claim 17, wherein the mapping protocol includes analysis of one or more attributes associated with a related message.

24. A method as recited in claim 17, wherein the mapping protocol includes consideration of a message template that has been selected by the user.

25. A method as recited in claim 17, wherein the mapping protocol includes analysis one or more attributes associated with one or more data types.

26. A method as recited in claim 17, wherein the mapping protocol includes application of data derived by a learning algorithm.

27. A method as recited in claim 11, wherein each data type is indicative of one or more detail fields.

28. A method as recited in claim 27, wherein the output indicative of proposed structured data provides one or more of the detail fields of which the structured data types included in the proposed structured data are indicative.

29. A method as recited in claim 28, wherein the providing of the additional input indicative of selective modification and/or approval of the proposed structured data includes editing and or approving information in the provided detail fields.

30. A method as recited in claim 29, wherein sending is permitted only in the case that each of the provided detail fields is populated.

31. A method as recited in claim 28, wherein one or more of the provided detail fields are automatically populated based on the analysis of the text.

32. A method as recited in claim 27, wherein for each data type the detail fields relate to aspects of that data type.

33. A method as recited in claim 32, wherein the detail fields include one or more detail fields that relate to deadlines or other dates.

34. A method as recited in claim 32, wherein the detail fields include one or more detail fields that relate to classifications.

35. A method as recited in claim 32, wherein the detail fields include one or more detail fields that relate to resource allocations.

36. A method as recited in claim 32, wherein the detail fields include one or more detail fields that relate to priority rankings.

37. A method as recited in claim 32, wherein the detail fields include one or more detail fields that relate to responsibility allocations.

38. A method as recited in claim 32, wherein the detail fields include one or more detail fields that relate to task acceptances or rejections.

39. A method as recited in claim 29, wherein either or both of the detail fields and the data type are provided in a graphical user interface as modifiable components.

40. A method as recited in claim 1, wherein the step of providing a signal indicative of proposed structured data is performed upon one or more predetermined conditions being met.

41. A method as recited in claim 40, wherein the one or more predetermined conditions include one or more of:
a user input;
input indicative of completion of receipt from the user input indicative of text; and
input indicative of completion of receipt from the user input indicative of a discrete fragment of text.

42. A method as recited in claim 41, wherein input indicative of a discrete segment of text includes input indicative of a paragraph of text.

43. A method as recited in claim 1, wherein the text is displayed to the user by way of a graphical user interface in a free-text message field and the signal indicative of proposed structured data is provided in, on and or adjacent the free-text message field.

44. A method as recited in claim 43, wherein the signal includes a tree diagram indicative of the proposed structured text.

45. A method as recited in claim 44, wherein the tree diagram is provided in a structured text preview field alongside the free-text message field.

46. A method as recited in claim 43, wherein the signal includes one or more modifiable items periodically superimposed on the free-text message field.

47. A method as recited in claim 1, wherein a signal indicative of the approved structured data is provided to an information management system.

48. A method as recited in claim 47, wherein the information management system is an activity management system.

49. A method as recited in claim 47, wherein the information management system is responsive to the signal indicative of the approved structured data for updating one or more records in a database.

50. A method as recited in claim 47, wherein the information management system is responsive to the signal indicative of the approved structured data for providing a signal indicative of a follow-up action.

51. A method as recited in claim 47, wherein the signal indicative of the approved structured data is provided to the information management system in response to one or more predetermined conditions being met.

52. A method as recited in claim 51, wherein the one or more predetermined conditions include a user command to provide an electronic message including the text.

53. A method as recited in claim 1, wherein the one or more predetermined text conditions include the presence of one or more predetermined key words.

54. A method as recited in claim 1, wherein the one or more predetermined text conditions include the presence of one or more predetermined grammatical structures.

55. A method as recited in claim 1, wherein the one or more predetermined text conditions include the presence of one or more predetermined text structures.

56. A method as recited in claim 1, wherein the one or more predetermined text conditions include the presence of one or more predetermined identifiers.

57. A method as recited in claim 55, wherein the one or more predetermined text structures includes text structured to identify a date or other point in time.

58. A method as recited in claim 56, wherein the one or more predetermined identifiers are indicative of one or more resources, items, projects, persons or locations.

59. A method as recited in claim 1, wherein the message consists of a single text fragment.

60. A method as recited in claim 1, wherein the output provided in (c) includes one or more modifiable components presented in a graphical user interface.

61. A computer-readable carrier medium carrying a set of instructions that when executed by one or more processors cause the one or more processors to carry out a method for providing structured data from a message authored by a user for sending to one or more recipients, the method comprising:
(a) accepting input indicative of a text fragment authored by the user;
(b) analyzing the accepted input to ascertain whether one or more predefined text conditions are met;
(c) in the case it is ascertained that one or more of the predefined conditions are met providing to the user output indicative of proposed structured data corresponding to the accepted input;
(d) accepting from the user additional input indicative of selective modification and/or approval of the proposed structured data;
(e) repeating steps (a) to (d) until all data indicative of all text fragments included in the message are accepted and analyzed,
such that, in the case that all data indicative of all text fragments included in the message are accepted, analyzed, and the structured data thereof modified and approved, one or both of the approved structured data and the message are sendable to one or more recipients.

62. A carrier medium as recited in claim 61, wherein the method further comprises:
(f) in the case that all data indicative of all text fragments included in the message are accepted, analyzed, and the structured data thereof modified and approved, sending one or both of the approved structured data and the message to one or more recipients.

63. A carrier medium as recited in claim 61, wherein the carrier medium is a medium bearing a propagated signal detectable by at least one processor of the one or more processors and representing the set of instructions.

64. A carrier medium as recited in claim 61, wherein the carrier medium is a carrier wave bearing a propagated signal detectable by at least one processor of the one or more processors and representing the set of instructions.

65. A carrier medium as recited in claim 61, wherein the carrier medium is a transmission medium in a network bearing a propagated signal detectable by at least one processor of the one or more processors and representing the set of instructions.

66. An apparatus for providing structured data from a free-text message for sending to one or more recipients, the apparatus comprising:
(a) means for accepting input indicative of a text fragment of the message;
(b) means for analyzing the accepted input to ascertain whether one or more predefined text conditions are met;
(c) means for in the case it is ascertained that one or more of the predefined conditions are met, providing to a user output indicative of proposed structured data corresponding to the accepted input;
(d) means for accepting from the user additional input indicative of selective modification and/or approval of the proposed structured data; and
(e) means for repeating steps (a) to (d) until all data indicative of all text fragments included in the message are accepted and analyzed,
such that in the case that all data indicative of all text fragments included in the message are accepted, analyzed, and the structured data thereof modified and approved, one or both of the approved structured data and the message are sendable to one or more recipients.
